(19) United States
(12) Patent Application Publication
(10) Pub. No.: US 2013/0076979 A1
(43) Pub. Date: Mar. 28, 2013

(54) VIDEO TRANSMITTING APPARATUS, VIDEO TRANSMITTING METHOD, VIDEO RECEIVING APPARATUS, VIDEO RECEIVING METHOD, AND VIDEO TRANSMITTING-RECEIVING APPARATUS

(71) Applicant: Shinya Kadono, Hyogo (JP)

(72) Inventor: Shinya Kadono, Hyogo (JP)

(21) Appl. No.: 13/700,551

(22) PCT Filed: Aug. 16, 2011
(86) PCT No.: PCT/JP2011/004599

§ 371 Date: Nov. 28, 2012

(30) Foreign Application Priority Data
Aug. 20, 2010 (JP) 2010-185604

(51) Int. Cl. H04N 7/025

(52) U.S. Cl. CPC H04N 7/025
USPC 348/466

(57) ABSTRACT

A video transmitting-receiving apparatus has a simple configuration to transmit and receive high-quality video via two-way communication between 50 Hz and 60 Hz regions. A 50 Hz-60 Hz arrangement unit determines whether an operating frequency of a receiving-side video transmitting-receiving apparatus is 50 Hz or 60 Hz from received information. The 50 Hz-60 Hz arrangement unit obtains an operating frequency of a transmitting-side transmitting-receiving apparatus from a display unit (or an input unit) and determines whether the transmitting-side frequency is the same as the receiving-side frequency. When the frequencies are the same, a coding unit codes interlaced video outputted from the input unit. When the frequencies are different, the coding unit codes progressive video obtained by IP conversion of the input unit and generates a progressive video stream. A transmission unit transmits, to the receiving side, the coded stream and information indicating the transmitting-side frequency.

### TECHNICAL FIELD

The present invention relates to: a video transmitting apparatus that receives interlaced video and transmits a coded stream via a network; a video transmitting method; a video receiving apparatus that decodes a stream received via a network and outputs resulting video; a video receiving method; and a video transmitting-receiving apparatus that implements both the video transmitting method and the video receiving method at the same time.

### BACKGROUND ART

As video signal formats, there are two different types of formats for interlaced video and progressive video.

A technique of interlaced video is also called interlaced scan. By interlaced scan, one frame includes two fields. On the assumption that a top line is a first line, one of the two fields is a top field that includes odd scan lines of the frame and the other is a bottom field that includes even scan lines of the frame. FIG. 14 is a diagram explaining a relationship between a frame and fields of interlaced video. The two fields included in one frame correspond to two images captured at different times. That is to say, one frame includes two images captured at two different times.

On the other hand, a technique of progressive video is also called progressive scan. By progressive scan, one frame includes an image captured at one time. One frame of progressive video includes a top field and a bottom field captured at one time (i.e., at the same time).

To be more specific, the number of scan lines and the number of pixels in an image (namely, a frame) included in progressive video captured at one time are both twice as large as those in an image (namely, a field) included in interlaced video captured at one time. Therefore, the number of pixels per second of progressive video is twice as large as that of interlaced video. On account of this, there is a disadvantage that, when the number of pixels in one frame is the same between progressive and interlaced video, a bit rate of a stream obtained by coding the progressive video is higher than a bit rate of a stream obtained by coding the interlaced video. Meanwhile, the number of pixels in an image included in interlaced video captured at one time corresponds to the number of pixels in one field. Therefore, when motion in video is fast, the number of pixels per unit time is ½ of the number of pixels in one frame. In other words, in the case of fast moving video, progressive video has an advantage of expressing a higher-resolution image.

Due to the historical' backgrounds, the 60 Hz television system is used in, for example, North America and Japan, whereas the 50 Hz television system is used in, for example, Europe and former communist countries. With the 60 Hz television system (referred to as “60 Hz” for the sake of simplification although it is 53.94 Hz to be precise in many cases), the number of interlaced images is 60 per second. With the 50 Hz television system, the number of interlaced images is 50 per second.

More specifically, the National Television System Committee (NTSC) standard is known as the 60 Hz analog television system, and the Phase Alternating Line (PAL) standard and the Sequentiel couleur a memoire (“Sequential Color with Memory”) (SECAM) standard are known as the 50 Hz television systems. Thus, two types of video apparatuses for 60 Hz and 50 Hz exist in the world. It should be noted that, in the following, each of the number of interlaced fields per second and the number of progressive frames per second is referred to as a “picture frequency”.

Although the two kinds of television systems for 50 Hz and 60 Hz are present in the world as described, either of the two systems is used within a region or a country. Thus, under present circumstances, cameras and displays in the region or the country are designed only for 50 Hz or 60 Hz, thereby reducing the cost of manufacturing and distributing video devices. To be more specific, in a region where the 50 Hz television system is used, not only televisions but also video devices, such as video recorders, DVD recorders, and movie digital cameras, that display images recorded therein on televisions are mostly designed to operate at 50 Hz. Similarly, in a region where the 60 Hz television system is used, such video devices are mostly designed to operate at 60 Hz.

In recent years, with the spread of high-speed networks and the globalization of economic activities, there has been a growth in the number of international video communications including international video conferences. The following describes a problem in a conventional technology, with reference to FIG. 15A, FIG. 15B, and FIG. 15C. Each of FIGS. 13A to 13C is a diagram explaining a relationship between the picture frequencies of video data transmitted and received between video transmitting-receiving apparatuses positioned in two locations.

FIG. 15A shows the case where video is transmitted and received between regions in both of which the 60 Hz television system is used. In the region for the 60 Hz television system, a camera and a display are both designed for 60 Hz. Thus, when a video transmitting-receiving apparatus operates at 60 Hz to transmit and receive a stream coded at 60 Hz, there are no problems in particular because all devices operate at 60 Hz.

FIG. 15B shows the case where video is transmitted and received between regions in both of which the 60 Hz television system is used. In the region for the 50 Hz television system, a camera and a display are both designed for 50 Hz. Thus, when a video transmitting-receiving apparatus operates at 50 Hz to transmit and receive a stream coded at 50 Hz, there are no problems in particular because all devices operate at 50 Hz.

FIG. 15C shows the case where video is transmitted and received between a region where the 50 Hz television system is used and a region where the 60 Hz television system is used. In this case, in the region for the 60 Hz television system, a camera and a display are designed for 60 Hz and a video transmitting-receiving apparatus also operates at 60 Hz to transmit a stream coded at 60 Hz. Here, when the video transmitting-receiving apparatus in the region for 60 Hz receives a coded stream from a video transmitting-receiving apparatus in the region for 50 Hz, the video transmitting-receiving apparatus in the region for 60 Hz needs to receive the stream coded at 50 Hz and then decode the received stream.

On the other hand, in the region for the 50 Hz television system, a camera and a display are designed for 50 Hz and the video transmitting-receiving apparatus also operates at 50 Hz to transmit a stream coded at 50 Hz. Here, when the video transmitting-receiving apparatus in the region for 50 Hz receives a coded stream from the video transmitting-receiving apparatus in the region for 60 Hz, the video transmitting-receiving apparatus in the region for 50 Hz needs to receive the stream coded at 60 Hz and then decode the received coded stream. In this way, when video is transmitted and received between the regions using different picture frequencies for the respective television systems, the video transmitting-receiving apparatus on the receiving side needs to decode the stream coded at one of the picture frequencies 50 Hz and 60 Hz different from the other one of the picture frequencies 50 Hz and 60 Hz at which a display unit of the video transmitting-receiving apparatus on the receiving side displays the video.

FIG. 16 is a diagram explaining the case where video is transmitted and received among video transmitting-receiving apparatuses positioned in three locations where different picture frequencies are used for the respective television systems. The following describes the case where video is transmitted and received among the three locations in which the 50 Hz and 60 Hz television systems are used as shown in FIG. 16. In this example, a camera and a display in the region for 60 Hz shown on the left in the diagram are designed for 60 Hz and, thus, a video transmitting-receiving apparatus also operates at 60 Hz. In other words, this video transmitting-receiving apparatus transmits a stream coded at 60 Hz.

However, when receiving video from a region for 60 Hz and a region for 50 Hz as shown on the right in the diagram, the aforementioned video transmitting-receiving apparatus needs to decode streams coded at the two different picture frequencies 50 Hz and 60 Hz and then display the decoded streams. This leads to a more difficult problem.

FIG. 17A and FIG. 17B are diagrams explaining a problem caused when the picture frequency of progressive video is converted between 50 Hz and 60 Hz. The video transmitting-receiving apparatus decodes the received stream to reconstruct the progressive video (this stream is described as “received images” in FIG. 17A and FIG. 17B). In the case of progressive video, the video transmitting-receiving apparatus displays a frame closest to a display time.

FIG. 17A shows a method of converting the picture frequency of progressive video from 60 Hz to 50 Hz. As shown in FIG. 17A, when the video transmitting-receiving apparatus used in the region for 50 Hz receives and decodes the stream coded at 60 Hz, a 50 Hz display of this video transmitting-receiving apparatus displays frames reconstructed every 1/60 of a second, at intervals of 1/50 of a second.

To do so, the video transmitting-receiving apparatus displays only frames closest to times corresponding to the intervals of 1/50 of a second, from among the frames reconstructed every 1/60 of a second. Therefore, although receiving and decoding a frame 151 and a frame 152, the video transmitting-receiving apparatus does not display these frames 151 and 152.

Generally speaking, in this case, one in every six received frames is not to be displayed. In other words, an image of 1/60 of a second corresponding to one frame is not displayed, thereby deteriorating image quality.

FIG. 17B shows a method of converting the picture frequency of progressive video from 50 Hz to 60 Hz. As shown in FIG. 17B, when the video transmitting-receiving apparatus used in the region for 60 Hz receives and decodes the stream coded at 50 Hz, a 60 Hz display of this video transmitting-receiving apparatus displays frames reconstructed every 1/50 of a second, at intervals of 1/60 of a second.

To do so, the video transmitting-receiving apparatus displays only frames closest to times corresponding to the intervals of 1/60 of a second, from among the frames reconstructed every 1/50 of a second. Therefore, the video transmitting-receiving apparatus receives and decodes a frame 153 and a frame 154 which are displayed twice in a row as frames 155 and 156 and frames 157 and 158, respectively.

Generally speaking, in this case, one in every five received frames is to be displayed twice in a row. In other words, a slight loss in image quality is caused because the same frame is displayed longer by 1/60 of a second corresponding to one frame.

FIG. 18A and FIG. 18B are diagrams explaining a problem caused when the picture frequency of interlaced video is converted between 50 Hz and 60 Hz. The video transmitting-receiving apparatus decodes the received stream to reconstruct the interlaced video. When the picture frequency of the received interlaced video is different from the picture frequency used in the video transmitting-receiving apparatus and the received interlaced video is to be displayed according to the picture frequency of the received interlaced video, the video transmitting-receiving apparatus displays a field of video closest to a display time.

It should be noted that interlaced video includes two kinds of fields which are a top field and a bottom field. As a protocol for interlaced video, the top field and the bottom field always have to be displayed alternately.

As shown in FIG. 18A, when the video transmitting-receiving apparatus used in the region for 50 Hz receives and decodes the stream coded at 60 Hz, the 50 Hz display of this video transmitting-receiving apparatus displays fields reconstructed every 1/60 of a second so that a top field and a bottom field are displayed, as a pair, at an interval of 1/50 of a second.

To do so, the video transmitting-receiving apparatus displays only a field that matches the corresponding identification “top” or “bottom” and is closest to a time corresponding to an interval of 1/25 of a second, from among the fields reconstructed every 1/60 of a second. Therefore, although receiving and decoding a field 161 and a field 162, the video transmitting-receiving apparatus does not display these fields 161 and 162.

Generally speaking, in this case, two in every 12 received fields are not to be displayed. Thus, of the received images, images of two fields corresponding to 1/30 of a second are not to be displayed, thereby leading to a serious loss in image quality. This loss in image quality is perceived when, for example: motion of a moving object in the video looks discontinuous instead of looking smooth; an object that should be gradually displayed appears suddenly; or an object that should gradually disappear disappears suddenly.

As shown in FIG. 18B, when the video transmitting-receiving apparatus used in the region for 60 Hz receives and decodes the stream coded at 50 Hz, the 60 Hz display of this video transmitting-receiving apparatus displays fields reconstructed every 1/50 of a second so that a top field and a bottom field are displayed, as a pair, at an interval of 1/60 of a second. To do so, this video transmitting-receiving apparatus displays only a field that matches the corresponding identification “top” or “bottom” and is closest to a time corresponding to an interval of 1/30 of a second, from among the fields reconstructed every 1/50 of a second.

Therefore, when receiving and decoding a top field 163 and a bottom field 164, the video transmitting-receiving apparatus displays the top field 163 twice as a top field 165 and a top field 167 and the bottom field 164 twice as a bottom filed 166 and a bottom field 168.

Generally speaking, in this case, two in every 10 received fields are to be displayed twice in a row. A particular problem here is that, although the top field 167 is displayed after the bottom field 166, the top field 167 is received earlier than the bottom field 166 in time order. To be more specific, the fields cannot be displayed in the order in which the fields are received. Thus, once every 12 fields, an object moving to the right appears to be moving to the left. This leads to an extremely serious loss in image quality.

FIG. 19 is a block diagram showing a configuration of a conventional video transmitting-receiving apparatus. In this diagram, the part other than a camera 1 and a display 2 corresponds to a video transmitting-receiving apparatus 3. The video transmitting-receiving apparatus 3 includes an input unit 10, a video memory 11, a coding unit 12, a transmission unit 13, a receiving unit 14, a decoding unit 15, a display unit 16, and a video memory 17.

A video signal received by the input unit 10 from the camera 1 is temporarily stored as video data into the video memory 11. The video data stored in the video memory 11 is coded into a stream by the coding unit 12. The coded stream is transmitted to a network by the transmission unit 13. Here, the main reasons why the input unit 10 temporarily stores the received video signal into the video memory 11 are described as follows.

1. The video signal received by the input unit 10 is received in scan order. Since the coding unit 12 codes the signal on a rectangular block basis, a unit of processing for accessing pixel data needs to be changed.

2. Although the video signal from the camera 1 is received by the input unit 10 at regular intervals of 50 Hz or 60 Hz, a coding operation time of the coding unit 12 varies depending on contents of the video. On this account, the video data needs to be temporarily stored until a time when the coding unit 12 can start coding.

The stream received by the receiving unit 14 from the network is decoded by the decoding unit 15. As a result, the video is reconstructed. The decoded video data is temporarily stored by the display unit 16 into the video memory 17. The video data stored in the video memory 17 is read by the display unit 16 and then outputted as the video signal to the display 2. Here, the main reasons why the display unit 16 temporarily stores the video data into the video memory 17 are described as follows.

1. The decoding unit 15 decodes the image in a rectangular block basis, and the video signal is outputted from the display unit 16 in scan order. Thus, a unit of processing for accessing pixel data needs to be changed.

2. Although the video signal from the display unit 16 is outputted to the display 12 at regular intervals of 50 Hz or 60 Hz, a decoding operation time of the decoding unit 15 varies depending on contents of the stream. On this account, the video data needs to be temporarily stored until a time when the decoding unit 15 completes decoding and thus the video data is displayable.

Here, each of the camera 1 and the display 2 needs to input and output the video signal at regular intervals of 50 Hz or 60 Hz according to video standards. In order to insure this, it is common for the input unit 10 and the display unit 16 of the video transmitting-receiving apparatus 3 to be configured with hardware that operates in synchronization with a reference clock at 50 Hz or 60 Hz. As described above, the 50 Hz or 60 Hz television system is predetermined according to a region or a country. For this reason, the portion including the camera 1, the display 2, the input unit 10, and the display unit 16 serves as a same-frequency operation unit R1 in which the units all operate at the same frequency, i.e., 50 Hz or 60 Hz.

As described above with reference FIG. 18A and FIG. 18B that explain the problem caused when the interlaced video is converted between 50 Hz and 60 Hz, the great loss is caused in image quality when the picture frequency is converted according to a simple method in the case where the 50 Hz interlaced video is displayed at 60 Hz or where the 60 Hz interlaced video is displayed at 50 Hz. Here, this loss in image quality can be reduced by a process called “Interlaced-to-Progressive (IP) conversion”.

FIG. 20 is a diagram explaining an example of a method for converting the picture frequency in the case where the video transmitting-receiving apparatus used in the region for 60 Hz receives the 50 Hz interlaced video. This video transmitting-receiving apparatus references to three fields inc ding the preceding field and the succeeding field, at each display time of the 50 Hz interlaced video. Here, the video transmitting-receiving apparatus generates one frame by adaptively choosing pixels used for reference, according to the amount of motion as described in the following 1 to 3. As a result, the video transmitting-receiving apparatus generates, as high-definition 50 Hz progressive video, the frame including a top field and a bottom field of the same time.

1. When the amount of motion is great, this means that the correlation between pixels is low. Thus, only pixels in one field of the same time are referenced. With this, when a progressive frame is to be generated, deterioration caused in conversion performance due to making reference to a pixel having a low correlation can be prevented.

2. When there is no motion, this means that the correlation between pixels is high. Thus, pixels of three fields are referenced. In the case of interlaced video, each of the pixel position of the field at the preceding time and the pixel position of the field at the succeeding time is different in the vertical position from the corresponding pixel position of the field at the conversion time (see FIG. 20). Thus, by reference to the two preceding and succeeding fields, conversion into a high-definition progressive frame can be implemented.

3. When the amount of motion is small, this means that the correlation between pixels is between the above cases 1 and 2. Thus, with priority being given to one field of the same time, the pixels of the two preceding and succeeding fields are also referenced.

This conversion from the interlaced video to the progressive video is called the IP conversion.

Conversion from 50 Hz progressive video to 60 Hz interlaced video is implemented by extracting a top field and a bottom field alternately, as a field close to a time at 60 Hz, from the 50 Hz progressive video. As a result, an image at one time is displayed twice in a row as a top field 181 and a bottom field 182, and another image at one time is displayed twice in a row as a top field 183 and the bottom field 184. However, these two fields of the same time are displayed merely 1/60 of a second longer than the other fields, thereby causing only a slight loss in image quality.

Similarly, FIG. 21 is a diagram explaining a method for converting the picture frequency in the case where the video transmitting-receiving apparatus used in the region for 50 Hz receives the 60 Hz interlaced video. As shown in this diagram, this video transmitting-receiving apparatus references to three fields including the preceding field and the succeeding field, at each time of displaying the corresponding field of the 60 Hz interlaced video. Here, the video transmitting-receiving apparatus generates one frame by adaptively choosing pixels used for reference, according to the amount of motion. As a result, the video transmitting-receiving apparatus generates, as high-definition 60 Hz progressive video, the frame including a top field and a bottom field of the same time. Conversion from 60 Hz progressive video to 50 Hz interlaced video is implemented by extracting a top field and a bottom field alternately, as a field close to a display time of the corresponding field at 50 Hz, from the 60 Hz progressive video. As a result, an image at a time corresponding to a frame 191 is not to be displayed. However, an image corresponding to merely 1/60 of a second is not displayed, thereby causing a slight loss in image quality.

A number of methods for converting interlaced video between 50 Hz and 60 Hz as described have been proposed (see Patent Literature 1).

### CITATION LIST

### Patent Literature

[PTL 1]

Japanese Unexamined Patent Application Publication No. 2002-369155

### SUMMARY OF INVENTION

### Technical Problem

With the spread of broadcasting and next-generation optical disks, rapid advances for full high-definition (HD) video have been made and also rapid advances for full HD interlaced cameras (1920×1080 pixels) have been made. In a conventional video conference, a progressive video camera (standard definition (SD) resolution: 704×480 pixels, HD resolution: 1280×720 pixels) is used. Thus, when a 50 Hz region and a 60 Hz region are connected via a network, there is no problem since only a slight loss is caused in image quality as explained above about the conversion of progressive video between 50 Hz and 60 Hz with reference to FIG. 17A and FIG. 17B.

However, when a full HD interlaced high-resolution camera that is gradually coming into use is used, a serious loss is caused in image quality as explained above about the conversion of interlaced video between 50 Hz and 60 Hz with reference to FIG. 18A and FIG. 18B.

Suppose that the input unit 10 or the display unit 16 shown in FIG. 19 implements a high degree of picture frequency conversion on the interlaced video such as when 50 Hz interlaced video is received in the 60 Hz region as shown in FIG. 20 or when 60 Hz interlaced video is received in the 50 Hz region as shown in FIG. 21. For this case, hardware that supports two reference clocks at 50 Hz and 60 Hz is required. Thus, a configuration of such a video transmitting-receiving apparatus is more complicated and more costly, as compared to the same-frequency operation unit R1.

Especially, suppose that video transmitting-receiving apparatuses in three regions having different television systems are to be connected or that video transmitting-receiving apparatuses in multiple regions, such as four or five regions, are to be connected. In order to implement a video transmitting-receiving apparatus that is capable of the aforementioned connections, conversion of interlaced images between 50 Hz and 60 Hz is needed in proportion to the number of received streams (i.e., the number of regions), which is impractical.

The present invention has an object to provide a video transmitting-receiving apparatus and the like having a simple configuration to transmit and receive high-quality interlaced video via two-way communication between regions for 50 Hz and 60 Hz television systems.

### Solution to Problem

In order to solve the conventional problem the video transmitting apparatus in an aspect according to the present invention is a video transmitting apparatus including: an input unit which receives interlaced video captured by a predetermined image pickup device and output video in a predetermined image format; a receiving unit which receives, from a video receiving apparatus to which the received interlaced video is to be transmitted, frequency information indicating a picture frequency representing the number of pictures displayed per unit time by the video receiving apparatus, each of the pictures being (i) a top field or a bottom field that is included in interlaced video or (ii) a frame included in progressive video; an arrangement unit which determines whether the picture frequency of the received interlaced video is a same as the picture frequency indicated by the frequency information received from the video receiving apparatus; a coding unit which codes the video outputted from the input unit to generate a stream; and a transmission unit which transmits the generated stream to the video receiving apparatus.

The picture frequency indicates whether the video receiving apparatus is for a 50 Hz television system or a 60 Hz television system, and the input unit (i) converts the received interlaced video into progressive video and outputs the progressive video when the arrangement unit determines that the picture frequency of the received interlaced video is different from the picture frequency indicated by the frequency information received from the video receiving apparatus, and (ii) outputs the received interlaced video with no change when the arrangement unit determines that the picture frequency of the received interlaced video is the same as the picture frequency indicated by the frequency information received from the video receiving apparatus.

As described, with the video transmitting apparatus in an aspect according to the present invention, when the picture frequency of the received interlaced video is different from the picture frequency received from the video receiving apparatus, the received interlaced video is converted into the progressive video and then the progressive video is outputted. Therefore, the video receiving apparatus that receives the progressive video from the video transmitting apparatus can convert the picture frequency of the video without causing a serious loss in image quality, as compared to the case of converting the picture frequency of the interlaced video.

Moreover, when the picture frequency of the received interlaced video is the same as the picture frequency received from the video receiving apparatus, the interlaced video received by the video transmitting apparatus is outputted as it is. Therefore, the video receiving apparatus can reproduce the interlaced video in which motion is smooth.

Furthermore, with the video transmitting apparatus in another aspect according to the present invention, when converting the interlaced video into the progressive video, the input unit may convert the interlaced video into the progressive video while maintaining the picture frequency of the interlaced video.

With this aspect, the video transmitting apparatus performs IP conversion to convert the interlaced video into the progressive video with the picture frequency of the interlaced video maintained, i.e., without converting the picture frequency. This can prevent the configuration of the video transmitting apparatus from being complicated and costly.

Moreover, with the video transmitting apparatus in another aspect according to the present invention, the arrangement unit may further determine whether one of a user input and a state of a communication channel satisfies a predetermined condition, when determining that the picture frequency of the video received by the video transmitting apparatus is the same as the picture frequency indicated by the frequency information received from the video receiving apparatus, and the input unit may convert the interlaced video into the progressive video when the arrangement unit determines that the predetermined condition is satisfied.

With this aspect, suppose that the user input or the state of the communication channel satisfies the predetermined condition, such as that the error tolerance of the video is set to be prioritized by the user input or that an error is likely to occur in the communication channel. In this case, even when the picture frequencies of the transmitting side and the receiving side are the same, the interlaced video with a low error tolerance can be converted into the progressive video with a high error tolerance and then this progressive video can be transmitted.

Furthermore, with the video transmitting apparatus in another aspect according to the present invention, the receiving unit may receive pieces of frequency information each of which is from a different one of a plurality of video receiving apparatuses, and the input unit may convert the interlaced video into the progressive video when the arrangement unit determines that at least one of the picture frequencies indicated by the pieces of frequency information received from the video receiving apparatuses is different from the picture frequency of the video received by the video transmitting apparatus.

To be more specific, with this aspect, suppose that the video transmitting apparatus transmits the received interlaced video to the plurality of video receiving apparatuses. In this case, when at least one of the picture frequencies received from the video receiving apparatuses is different from the picture frequency of the video inputted to the video transmitting apparatus, the received interlaced video is converted into the progressive video. In other words, when at least one of the video receiving apparatuses has a different picture frequency, this means that the progressive video is to be transmitted to all the video receiving apparatuses.

With this, processing load of the video transmitting apparatus can be reduced, as compared to the case where the interlaced video or the progressive video is selectively transmitted according to the picture frequency of the corresponding video receiving apparatus. Moreover, the video receiving apparatus having the different picture frequency can reproduce the video after the picture frequency is converted without causing a serious loss in image quality.

Moreover, with the video transmitting apparatus in another aspect according to the present invention, when converting the interlaced video into the progressive video, the input unit may further reduce the number of pixels included in each of frames of the progressive video in order for the number of pixels per second of the progressive video obtained by the conversion to be smaller than or equal to the number of pixels per second of the interlaced video before the conversion.

With this aspect, when the interlaced video is converted into the progressive video, the number of pixels included in each of the frames of the progressive video is reduced. This solves the problem that is caused when the interlaced video is converted into the progressive video without converting the picture frequency of the interlaced video and thus the number of pixels per second of the progressive video is doubled. Moreover, with this, the number of pixels per second of the progressive video after the conversion is prevented from increasing as compared to the number of pixels per second of the interlaced video before the conversion.

With this, processing load, communication load, and the like required of the video transmitting apparatus can be prevented from increasing. Moreover, although the resolution of the video reproduced by the video receiving apparatus is reduced, the reproduction can be executed after the picture frequency is converted without causing a serious loss in image quality of the video.

Furthermore, with the video transmitting apparatus in another aspect according to the present invention, when converting the interlaced video into the progressive video, the input unit may further reduce the number of frames of the progressive video in order for the number of pixels per second of the progressive video obtained by the conversion to be smaller than or equal to the number of pixels per second of the interlaced video before the conversion.

With this aspect, when the interlaced video is converted into the progressive video, the number of frames in the progressive video after the conversion is reduced. This solves the problem that is caused when the interlaced video is converted into the progressive video without converting the picture frequency of the interlaced video and thus the number of pixels per second of the progressive video is doubled. Moreover, with this, the number of pixels per second of the progressive video after the conversion is prevented from increasing as compared to the number of pixels per second of the interlaced video before the conversion.

With this, processing load, communication load, and the like required of the video transmitting apparatus can be prevented from increasing. Moreover, although the motion smoothness of the video reproduced by the video receiving apparatus is reduced, the reproduction can be executed after the picture frequency is converted without causing a serious loss in image quality of the video.

Moreover, the video transmitting apparatus in another aspect according to the present invention may further include a mode setting holding unit which holds a mode setting of a coding mode, the mode setting being set by a user and including image quality specification, wherein the input unit may (i) convert the interlaced video into the progressive video and reduce the number of frames of the progressive video in order for the number of pixels per second of the progressive video obtained by the conversion to be smaller than or equal to the number of pixels per second of the interlaced video before the conversion, when the image quality specification included in the held mode setting does not indicate motion priority; (ii) output the interlaced video with no change, when the image quality specification included in the held mode setting indicates motion priority and the arrangement unit determines the picture frequencies are the same; and (iii) convert the interlaced video into the progressive video, reduce the number of pixels included in each of frames of the progressive video in order for the number of pixels per second of the progressive video obtained by the conversion to be smaller than or equal to the number of pixels per second of the interlaced video before the conversion, and output the resulting progressive video, when the image quality specification included in the held mode setting indicates motion priority and the arrangement unit determines the picture frequencies are different from each other.

With this aspect, the video transmitting apparatus determines the case (i), (ii), or (iii), and can output the optimum video based on the result of the determination. To be more specific, suppose (ii) that the user-specified image quality indicates motion priority and that the video transmitting apparatus determines that the picture frequencies of the transmitting side and the receiving side are the same. In this case, the interlaced video in which motion is smooth can be outputted. Here, in the case where the picture frequency needs to be converted, a great loss is caused in image quality.

Moreover, suppose (iii) that the user-specified image quality indicates motion priority and that the video transmitting apparatus determines that the picture frequencies of the transmitting side and the receiving side are different from each other. In this case, even when the picture frequency is converted, a loss caused in image quality is only slight because of the progressive video. Then, the video transmitting apparatus outputs the progressive video in which the number of pixels included in each of the frames is reduced in order for the number of pixels per second of the progressive video obtained by the conversion to be smaller than the number of pixels per second of the interlaced video before the conversion. Therefore, although motion of the progressive video is not as smooth as that of the interlaced video, the video transmitting apparatus can output the progressive video including more smooth motion as compared to the progressive video in which the number of frames is reduced.

Furthermore, suppose (i) that the user-specified image quality does not indicate motion priority. In this case, regardless of whether or not the picture frequency of the video receiving apparatus is the same as that of the video transmitting apparatus, the video transmitting apparatus outputs the progressive video in which the number of frames is reduced in order for the number of pixels per second of the progressive video obtained by the conversion to be smaller than the number of pixels per second of the interlaced video before the conversion.

With this, when the user-specified image quality does not indicate motion priority and the picture frequency is converted, a loss in image quality is only slight because of the progressive video. Then, the video transmitting apparatus outputs the progressive video in which the number of frames is reduced in order for the number of pixels per second of the progressive video obtained by the conversion to be smaller than the number of pixels per second of the interlaced video before the conversion. Therefore, although smooth motion cannot be reproduced when the video includes the great amount of motion, the high-definition images can be reproduced when the amount of motion in the video is small since the number of pixels in each of the frames is not reduced.

It should be noted that the present invention can be implemented not only as an apparatus, but also as: an integrated circuit having processing units included in the apparatus; a method having, as steps, the processing units included in apparatus; a computer program causing a computer to execute the steps included in the method; and information, data, or a signal indicating the computer program. The computer program, the information, the data, and the signal may be distributed via a recording medium such as a Compact Disc-Read Only Memory (CD-ROM) or via a communication medium such as the Internet

### Advantageous Effects of Invention

The video transmitting apparatus according to the present invention obtains, from the video receiving apparatus, the frequency information indicating the picture frequency of the television system used when the video receiving apparatus displays video. When the picture frequency of the video inputted to the video transmitting apparatus is different from the picture frequency indicated by the obtained frequency information, the video transmitting apparatus transmits a stream obtained by progressive video coding to the video receiving apparatus. Thus, the video receiving apparatus can decode the received stream as the progressive video. Therefore, even when the picture frequency of the decoded video is different from the picture frequency at which the display unit displays the video, the 50 Hz or 60 Hz video can be displayed by a simple configuration with only a slight loss in image quality. Moreover, when the picture frequency of the video inputted to the video transmitting apparatus is the same as the picture frequency indicated by the obtained frequency information, the video transmitting apparatus can transmit, to the video receiving apparatus, a stream obtained by coding the interlaced video with high precision as it is received from the camera.

### BRIEF DESCRIPTION OF DRAWINGS

[FIG. 1]

FIG. 1 is a block diagram showing a configuration of a video transmitting-receiving apparatus in Embodiment 1.

[FIG. 2A]

FIG. 2A is a flowchart showing an example of an operation performed by a video transmitting apparatus in Embodiment 1.

[FIG. 2B]

FIG. 2B is a flowchart showing another example of the operation performed by the video transmitting apparatus in Embodiment 1.

[FIG. 3]

FIG. 3 is a flowchart showing an example of an operation performed by the video transmitting-receiving apparatus on the receiving side in Embodiment 1.

[FIG. 4]

FIG. 4 is a table showing a relationship between an image format and the number of pixels.

[FIG. 5]

FIG. 5 is a block diagram showing a more detailed configuration of an input unit in Embodiments 2 and 3.

[FIG. 6]

FIG. 6 is a diagram explaining a principle of P conversion including resolution reduction that is performed by the input unit in Embodiment 2.

[FIG. 7A]

FIG. 7A is a flowchart showing an example of an operation for IP conversion including resolution reduction that is performed by the video transmitting-receiving apparatus in Embodiment 2.

[FIG. 7B]

FIG. 7B is a flowchart showing another example of the operation for IP conversion including resolution reduction that is performed by the video transmitting-receiving apparatus in Embodiment 2.

[FIG. 8]

FIG. 8 is a diagram explaining a principle of IP conversion including frame reduction that is performed by the input unit in Embodiment 3.

[FIG. 9]

FIG. 9 is a flowchart showing an example of an operation for IP conversion including frame reduction that is performed by the video transmitting-receiving apparatus in Embodiment 3.

[FIG. 10]

FIG. 10 is a block diagram showing a configuration of a video transmitting apparatus in Embodiment 4.

[FIG. 11]

FIG. 11 is a block diagram showing a configuration of a video receiving apparatus in Embodiment 5.

[FIG. 12A]

FIG. 12A is a diagram showing a relationship between a user setting of a coding mode and a corresponding coded image in the case where a video transmitting apparatus is not assumed to communicate with a video receiving apparatus having a picture frequency different from a picture frequency of the video transmitting apparatus, in Embodiment 6.

[FIG. 12B]

FIG. 12B is a diagram showing a relationship between a user setting of a coding mode and a corresponding coded image in the case where a video transmitting apparatus is assumed to communicate with a video receiving apparatus having a picture frequency different from a picture frequency of the video transmitting apparatus, in Embodiment 6.

[FIG. 13]

FIG. 13 is a flowchart showing an operation for IP conversion performed by the video transmitting apparatus according to the user setting of the coding mode, in Embodiment 6.

[FIG. 14]

FIG. 14 is a diagram explaining a relationship between a frame and fields of interlaced video.

[FIG. 15A]

FIG. 15A is a diagram explaining a relationship between picture frequencies of transmitted video and received video in the case where the video is transmitted and received between video transmitting-receiving apparatuses at two locations in regions both using the 60 Hz television system.

[FIG. 15B]

FIG. 15B is a diagram explaining a relationship between picture frequencies of transmitted video and received video in the case where the video is transmitted and received between two locations in regions both using the 50 Hz television system.

[FIG. 15C]

FIG. 15C is a diagram explaining a relationship between picture frequencies of transmitted video and received video in the case where the video is transmitted and received between video transmitting-receiving apparatuses at two locations in regions using the 60 Hz and 50 Hz television systems.

[FIG. 16]

FIG. 16 is a diagram explaining a relationship between picture frequencies of transmitted video and received video in the case where the video is transmitted and received among video transmitting-receiving apparatuses at three locations each using a different picture frequency for the corresponding television system.

[FIG. 17A]

FIG. 17A is a diagram explaining a problem caused when the picture frequency 60 Hz of progressive video is converted to the picture frequency 50 Hz of progressive video.

[FIG. 17B]

FIG. 17B is a diagram explaining a problem caused when the picture frequency 50 Hz of progressive video is converted to the picture frequency 60 Hz of progressive video.

[FIG. 18A]

FIG. 18A is a diagram explaining a problem caused when the picture frequency 60 Hz of interlaced video is converted to the picture frequency 50 Hz of interlaced video.

[FIG. 18B]

FIG. 18B is a diagram explaining a problem caused when the picture frequency 50 Hz of interlaced video is converted to the picture frequency 60 Hz of interlaced video.

[FIG. 19]

FIG. 19 is a block diagram showing a configuration of a conventional video transmitting-receiving apparatus.

[FIG. 20]

FIG. 20 is a diagram explaining a method for converting the picture frequency in the case where the receiving apparatus used in the region for the 60 Hz television system receives 50 Hz interlaced video.

[FIG. 21]

FIG. 21 is a diagram explaining a method for converting the picture frequency in the case where the video receiving apparatus used in the region for the 50 Hz television system receives 60 Hz interlaced video.

### DESCRIPTION OF EMBODIMENTS

The following is a description of Embodiments according to the present invention, with reference to the drawings.

### Embodiment 1

A video transmitting-receiving apparatus in Embodiment 1 transmits interlaced video to a video transmitting-receiving apparatus to connect to and receives, from the video transmitting-receiving apparatus to connect to, frequency information indicating an operating frequency of the video transmitting-receiving apparatus on the receiving side that receives the interlaced video. When the operating frequency indicated by the received frequency information is different from an operating frequency of the video transmitting-receiving apparatus on the transmitting side, the video transmitting-receiving receiving apparatus on the transmitting side converts the interlaced video into progressive video and then transmits the progressive video to the video transmitting-receiving apparatus to connect to.

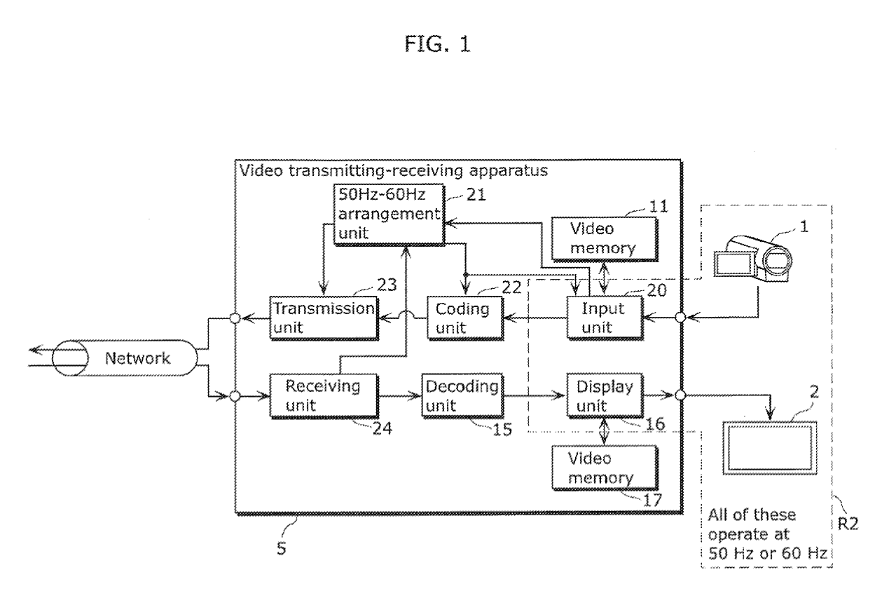

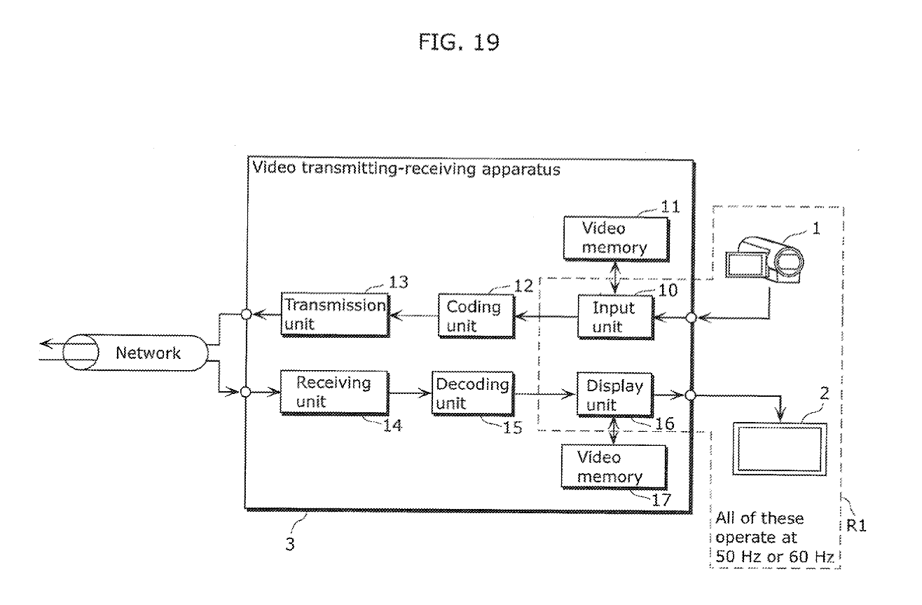

FIG. 1 is a block diagram showing a configuration of a video transmitting-receiving apparatus in Embodiment 1. In this diagram, devices performing the same operations as the units included in the conventional video transmitting-receiving apparatus shown in FIG. 19 are assigned the same numbers as used in FIG. 19 and explanations about such devices are omitted here. As shown in FIG. 1, a video transmitting-receiving apparatus 5 includes an input unit 20, a video memory 11, a 50 Hz-60 Hz arrangement unit 21, a coding unit 22, a transmission unit 23, a receiving unit 24, a decoding unit 15, a display unit 16, and a video memory 17.

When the 50 Hz-60 Hz arrangement unit 21 determines that the operating frequency of the video transmitting-receiving apparatus 5 is different from the operating frequency of the video transmitting-receiving apparatus to connect to, the input unit 20 performs IP conversion to convert the received interlaced video into progressive video.

The 50 Hz-60 Hz arrangement unit 21 obtains the operating frequency of the video transmitting-receiving apparatus 5 from the input unit 20. Moreover, the 50 Hz-60 Hz arrangement unit 21 determines, from the frequency information received from the video transmitting-receiving apparatus to connect to, whether the operating frequency of the video transmitting-receiving apparatus to connect to is 50 Hz or 60 Hz, and then determines whether the operating frequency of the video transmitting-receiving apparatus 5 is the same as the operating frequency of the video transmitting-receiving apparatus to connect to.

When the 50 Hz-60 Hz arrangement unit 21 determines that the operating frequency of the video transmitting-receiving apparatus 5 is different from the operating frequency of the video transmitting-receiving apparatus to connect to, the coding unit 22 performs progressive coding on the video data outputted from the input unit 20. When these operating frequencies are determined to be the same, the coding unit 22 performs interlaced coding on the video data outputted from the input unit 20.

The transmission unit 23 transmits frequency information indicating the operating frequency of the video transmitting-receiving apparatus 5 to the video transmitting-receiving apparatus to connect to via a network. When the 50 Hz-60 Hz arrangement unit 21 determines that the operating frequency of the video transmitting-receiving apparatus 5 is different from the operating frequency of the video transmitting-receiving apparatus on the receiving side, the transmission unit 23 transmits the progressive coded stream to the video transmitting-receiving apparatus to connect to. When the operating frequencies are determined to be the same, the transmission unit 23 transmits the interlaced coded stream to the video transmitting-receiving apparatus to connect to.

The receiving unit 24 receives the coded stream from the video transmitting-receiving apparatus to connect to and then outputs the received stream to the decoding unit 15. Moreover, the receiving unit 24 receives the frequency information indicating the operating frequency of the video transmitting-receiving apparatus to connect to and outputs the received frequency information to the 50 Hz-60 Hz arrangement unit 21.

It should be noted that the video transmitting-receiving apparatus may transmit and receive the frequency information to and from the video transmitting-receiving apparatus to connect to at the following timing. (1) The frequency information may be transmitted or received when the video transmitting-receiving apparatus on the receiving side is connected to the network. (2) A server storing the frequency information of the video transmitting-receiving apparatus may be provided on the network, and then the frequency information may be transmitted or received via the server at any timing when a network connection is established. (3) A server connected to the network may store the frequency information regarding all the video transmitting-receiving apparatuses, and each of the video transmitting-receiving apparatuses may only receive the frequency information regarding the apparatus to connect to from the server without transmitting the frequency information.

In the cases of (2) and (3), the video transmitting-receiving apparatus on the transmitting side may obtain the frequency information regarding the video transmitting-receiving apparatus on the receiving side as follows. For example, the video transmitting-receiving apparatus on the transmitting side may obtain an apparatus ID of the video transmitting-receiving apparatus on the receiving side, the apparatus ID being included in a connection request, a video transmission request, and the like received from the video transmitting-receiving apparatus on the receiving side. Then, based on the obtained apparatus ID, the video transmitting-receiving apparatus on the transmitting side may read, from the server, the frequency information corresponding to the apparatus ID.

In the above, the 50 Hz-60 Hz arrangement unit 21 is described as obtaining the information regarding the operating frequency of the video transmitting-receiving apparatus 5 from the input unit 20. However, when the operating frequency is fixed at 50 Hz or 60 Hz, the information does not need to be obtained and the operating frequency may be determined from a switch setting or ID information recorded on a nonvolatile memory.

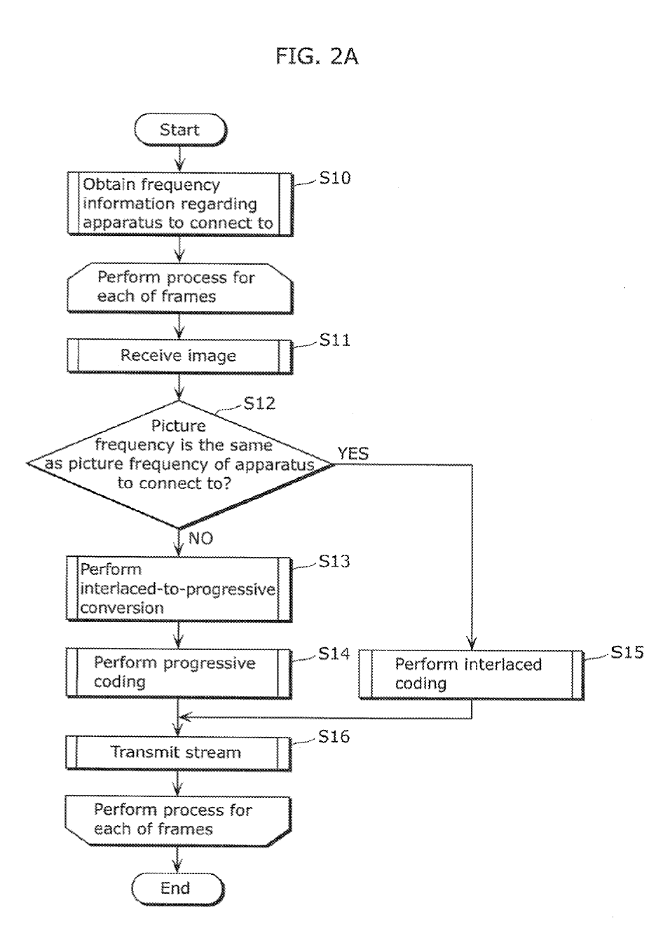

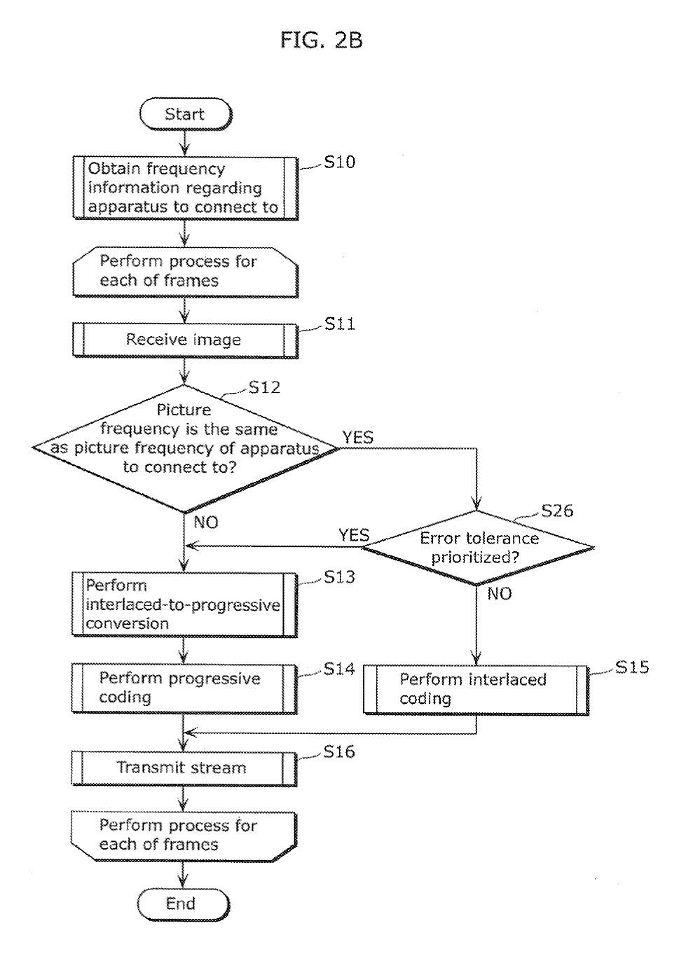

A process performed by the video transmitting-receiving apparatus 5 on the video transmitting side configured as described thus far is explained with reference to the flowchart shown in FIG. 2A.

Firstly, the 50 Hz-60 Hz arrangement unit 21 of the video transmitting-receiving apparatus 5 obtains the frequency information received by the receiving unit 24 and indicating whether the operating frequency of the television system used by the video transmitting-receiving apparatus to connect to is 50 Hz or 60 Hz (S10). The input unit 20 temporarily stores a video signal received from the camera 1 into the video memory 11 (S11). The 50 Hz-60 Hz arrangement unit 21 obtains, from the input unit 20, whether the operating frequency of the video transmitting-receiving apparatus 5 is 50 Hz or 60 Hz, and determines, by comparison, whether the obtained operating frequency is the same as the operating frequency of the video transmitting-receiving apparatus on the receiving side that is received by the receiving unit 24 (S12).

In S12, when the 50 Hz-60 Hz arrangement unit 21 determines that the operating frequencies are the same (YES in S12), the coding unit 22 codes the interlaced video outputted from the input unit 20 into an interlaced video stream.

On the other hand, when the 50 Hz-60 Hz arrangement unit 21 determines in S12 that the operating frequencies are different from each other (NO in S12), the input unit 20 performs IP conversion to convert the interlaced video signal inputted to the input unit 20 into progressive video (S13). Then, the coding unit 22 codes the progressive video obtained as a result of the conversion to generate a progressive video stream (S14).

The transmission unit 23 transmits the stream coded by the coding unit 22 to the video transmitting-receiving apparatus on the receiving side via the network (S16).

The operation from S11 to S16 described thus far is performed for each of frames included in the video.

In the above example, when the 50 Hz-60 Hz arrangement unit determines that the operating frequency of the video transmitting-receiving apparatus 5 is the same as the operating frequency of the video transmitting-receiving apparatus on the receiving side, the stream obtained by coding the interlaced video is transmitted to the video transmitting-receiving apparatus on the receiving side. However, note that the present invention is not limited to this. For example, even when the operating frequency of the video transmitting-receiving apparatus 5 is the same as the operating frequency of the video transmitting-receiving apparatus on the receiving side, IP conversion may be performed according to the state of a communication channel or a user setting and then the stream obtained by coding the progressive video may be transmitted to the video transmitting-receiving apparatus on the receiving side.

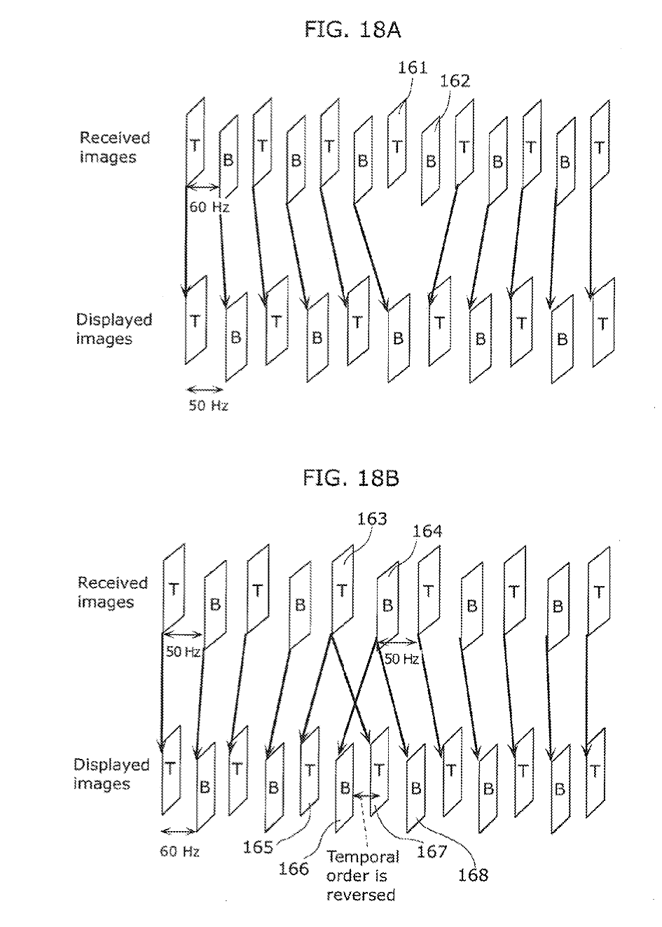

This is because, for example, interlaced video has a disadvantage of being more susceptible to a data loss caused by a communication error or the like as compared to progressive video. To be more specific, in the case of interlaced video, an image cannot be received on a field basis due to an error. Here, a top field and a bottom field included in the interlaced video need to be alternately displayed. On this account, when a field that cannot be received due to an error is substituted by a top or bottom field closest in time to this field, the display time is definitely reversed between the bottom field and the top field for the same reason as described with reference to FIG. 18B.

From the aforementioned reason, (1) the video transmitting-receiving apparatus 5 may receive an occurrence rate of receiving error regularly from the video transmitting-receiving apparatus on the receiving side and, when the error occurrence rate is higher than a threshold, may perform IP conversion even when the operating frequencies of the video transmitting-receiving apparatus 5 and the video transmitting-receiving apparatus on the receiving side are the same. Moreover, (2) the user may set in advance, using the input unit 20, a mode where the error tolerance of the received stream is prioritized and, when the mode prioritizing the error tolerance is set, the video transmitting-receiving apparatus 5 may perform IP conversion even when the operating frequencies of the video transmitting-receiving apparatus 5 and the video transmitting-receiving apparatus on the receiving side are the same.

FIG. 2B is a flowchart showing another example of the operation performed by the video transmitting apparatus in Embodiment 1. As shown in this diagram, for example, the 50 Hz-60 Hz arrangement unit 21 determines whether the operating frequency of the video transmitting-receiving apparatus 5 is the same as the operating frequency of the video transmitting-receiving apparatus on the receiving side (S12). When determining that the operating frequencies are the same, the 50 Hz-60 Hz arrangement unit 21 further determines whether the video transmitting-receiving apparatus 5 is set to the mode prioritizing the error tolerance (S26). When it is determined that the video transmitting-receiving apparatus 5 is set to the mode prioritizing the error tolerance, the input unit 20 performs IP conversion (S13). When it is determined in S26 that the video transmitting-receiving apparatus 5 is not set to the mode prioritizing the error tolerance, the coding unit 22 performs interlaced coding (S15). To be more specific, in S26, (1) the 50 Hz-60 Hz arrangement unit 21 determines that the mode prioritizing the error tolerance is set when, for example, the occurrence rate of receiving error informed by the video transmitting-receiving apparatus on the receiving side exceeds the threshold. Alternatively, (2) the 50 Hz-60 Hz arrangement unit 21 determines that the mode prioritizing the error tolerance is set when the mode prioritizing the error tolerance is set by the user input.

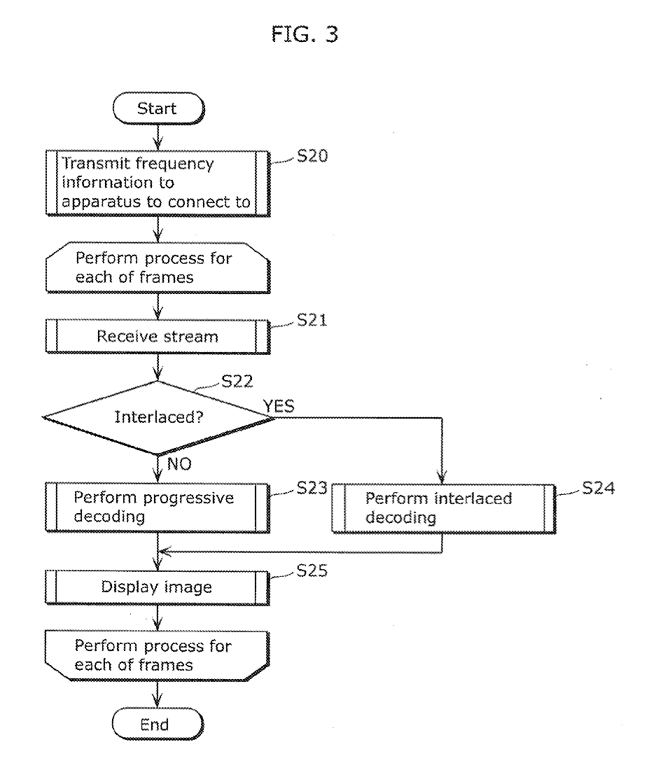

FIG. 3 is a flowchart showing an example of an operation performed by the video transmitting-receiving apparatus on the receiving side in Embodiment 1. Next, a process performed by the video transmitting-receiving apparatus on the video receiving side is explained with reference to the flowchart shown in FIG. 3.

The transmission unit 23 generates the frequency information indicating the operating frequency obtained from the input unit 20 and then transmits the generated frequency information to the video transmitting-receiving apparatus to connect to via the network (S20).

The receiving unit 24 receives the stream from the video transmitting-receiving apparatus to connect to via the network (S21), and then the decoding unit 15 decodes the received stream. Identification information indicating whether the stream is interlaced video or progressive video is included in this stream.

The decoding unit 15 determines from the identification information included in the stream whether or not the current stream is interlaced video (S22). When determining that the stream is interlaced video (YES in S22), the decoding unit 15 decodes the stream as interlaced video (S24). When determining that the stream is not interlaced video (NO in S22), the decoding unit 15 decodes the stream as progressive video (S23).

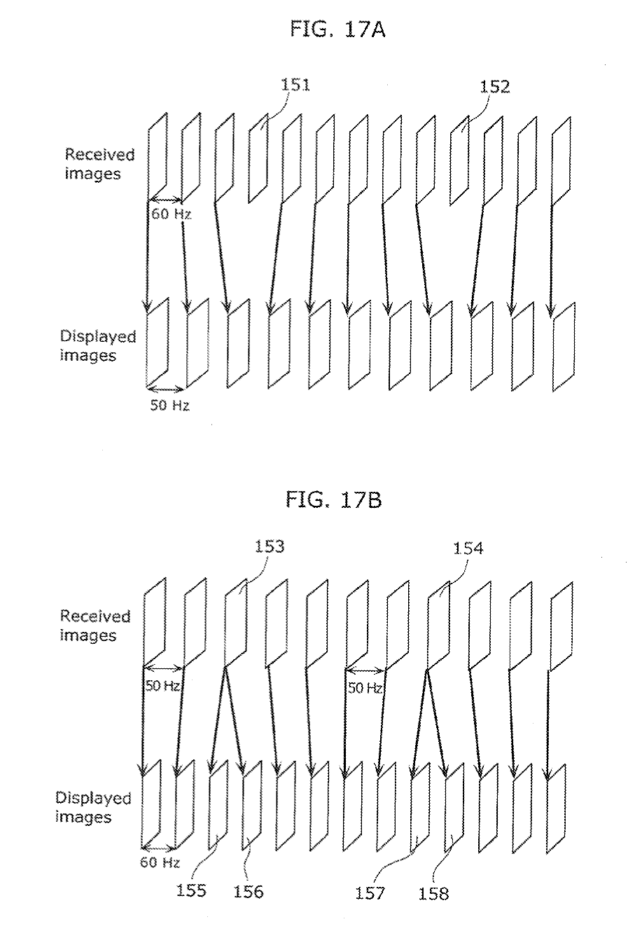

The decoded video is temporarily stored by the display unit 16 into the video memory 17. When the picture frequency of the decoded video is different from the picture frequency of the television system used by the display unit 16, the picture frequency of the decoded video is converted according to the method shown in 17A or FIG. 17B and outputted as a video signal driving the display 2 (S25).

The operation from S20 to S25 described thus far is performed for each of frames included in the video.

According to the above operation, when the operating frequency of the video transmitting-receiving apparatus 5 is the same as the operating frequency of the video transmitting-receiving apparatus to connect to, the video transmitting-receiving apparatus 5 can transmit and receive the stream obtained by coding the interlaced video. Moreover, when the operating frequency of the video transmitting-receiving apparatus 5 is different from the operating frequency of the video transmitting-receiving apparatus to connect to, the input unit 20 can convert interlaced video inputted from the camera 1 into progressive video and the video transmitting-receiving apparatus 5 can transmit and receive the stream obtained by coding the progressive video.

Thus, when the operating frequencies of the video transmitting-receiving apparatuses on the transmitting side and the receiving side are the same, the interlaced video can be displayed on the receiving side without any problem. Moreover, even when the operating frequencies of the video transmitting-receiving apparatuses on the transmitting side and the receiving side are different from each other, the progressive video can be converted between 50 Hz and 60 Hz as shown in FIG. 17A and FIG. 17B and the video can be displayed with only a slight loss in image quality.

It should be noted that the operating frequency of a same-frequency operation unit R2 shown in FIG. 1 is the same as each of the operating frequencies of the camera 1 and the display 2. Suppose that the operating frequency of the progressive video received via the network and decoded by the decoding unit 15 is different from the operating frequency of the same-frequency operation unit R2. In this case, the decoded video data is temporarily stored into the video memory 17, and the display unit 16 in the same-frequency operation unit R2 reads the video data from the video memory element 17 to display the read video data on the display 2. Accordingly, a desired operation can be implemented.

### Embodiment 2

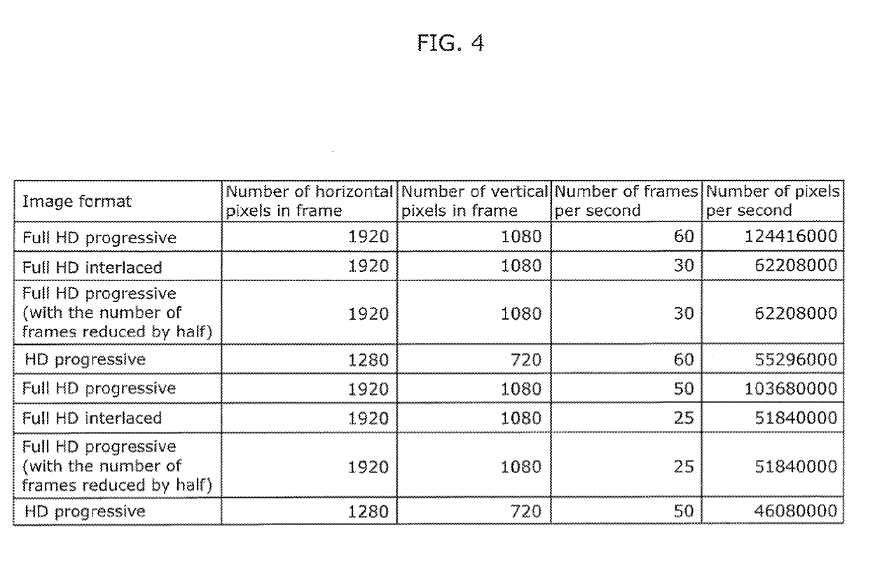

FIG. 4 is a table showing a relationship between an image format of video and the number of pixels of the video. These days, full HD interlaced video cameras are used predominantly. At 60 Hz (30 frames per second and 60 fields per second), the number of pixels per second is about 62000000 pixels (see the second row from the top in FIG. 4). At 50 Hz (25 frames per second and 50 fields per second), the number of pixels per second is about 52000000 pixels (see the sixth row from the top in FIG. 4). When full HD interlaced video is converted into full HD progressive video, the number of pixels per second is doubled to about 124000000 pixels (see the first row from the top in FIG. 4) and the bit rate of the coded stream is also increased. On the other hand, when full HD interlaced video is converted into HD progressive video in a resolution of 1280×720 pixels that is said to be HD resolution, the number of pixels per second is about 55000000 pixels at 60 Hz (see the fourth row from the top in FIG. 4) and is about 46000000 pixels at 50 Hz (see the eighth row from the top in FIG. 4). Here, the numbers of pixels are slightly reduced as compared to the case of full HD interlaced video. Therefore, the bit rate of the coded stream is unlikely to be higher than the bit rate of the full HD interlaced video. On account of this, when the operating frequency 50 Hz or 60 Hz is different between the video transmitting-receiving apparatus on the transmitting side and the video transmitting-receiving apparatus on the receiving side, the conversion from the full HD interlaced video to the HD progressive video allows a change in the bit rate of the coded stream caused due to the different operating frequency of the video transmitting-receiving apparatus on the receiving side to be small. Thus, the communication load of the network is smoothed out and, as a result, stable communication can be achieved.

Suppose that full HD interlaced video is converted into “full HD [frames-reduced-by-half] progressive video” where the resolution is maintained as full HD and the number of frames per second is reduced by half, instead of being converted into the HD progressive video in the resolution of 1280×720 pixels that is said to be HD resolution. In this case, the number of pixels per second is about 62000000 pixels at 60 Hz (30 frames per second) (see the third row from the top in FIG. 4), and is about 52000000 pixels at 50 Hz (25 frames per second) (see the seventh row from the top in FIG. 4).

As described, the number of pixels per second of the full HD interlaced video is the same as the number of pixels per second of the case where the full HO interlaced video is converted into the full HD [frames-reduced-by-half] progressive video. However, the number of vertical pixels for each image is doubled in the full HD [frames-reduced-by-half] progressive video as compared to the full HD interlaced video, meaning that the image is displayed with higher definition. Yet, a time interval between images to be displayed from the full HD [frames-reduced-by-half] progressive video is doubled, meaning that motion traceability in the case of video including fast motion is inferior as compared to the full HD interlaced video.

Therefore, when the resolution is prioritized, i.e., when high-definition image is desired in the case where the bit rate is not to be changed and motion included in the video is relatively small, the full HD [frames-reduced-by-half] progressive video is suitable. On the other hand, when motion is prioritized, i.e., when video includes a great amount of motion and smooth motion is desired, the full HD interlaced video is suitable.

The processing loads for coding and decoding are next described. In the case of full HD [frames-reduced-by-half] progressive video, data of about 2000000 pixels per frame needs to be processed every 1/30 of a second at 60 Hz and every 1/25 of a second at 50 Hz. However, in the case of full HD interlaced video, data of about 1000000 pixels per field needs to be processed every 1/60 of a second at 60 Hz and every 1/50 of a second at 50 Hz. Thus, this case has an advantage that the operating frequency can be low.

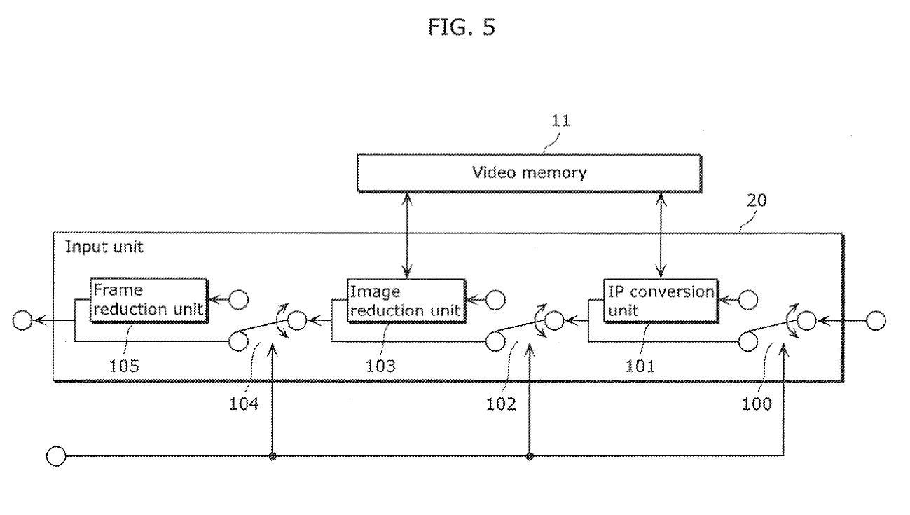

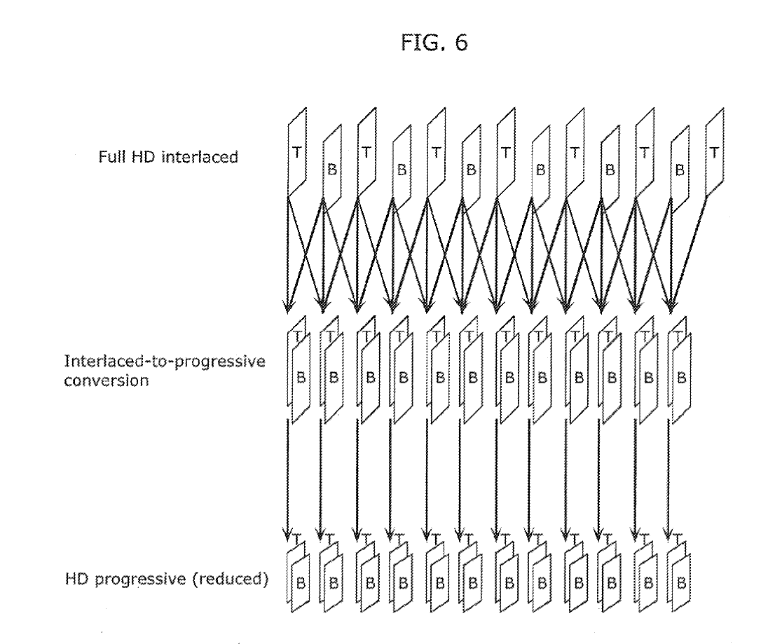

FIG. 5 is a block diagram showing a more detailed configuration of the input unit 20 in Embodiment 2. FIG. 6 is a diagram explaining a principle of IP conversion including resolution reduction that is performed by the input unit in Embodiment 2.

As shown in FIG. 5, the input unit 20 includes a selector switch 100, an IP conversion unit 101, a selector switch 102, an image reduction unit 103, a selector switch 104, and a frame reduction unit 105. The selector switch 100 is switched to a lower terminal bypassing the IP conversion unit 101 when the 50 Hz-60 Hz arrangement unit 21 determines that the operating frequency of the video transmitting-receiving apparatus 5 is the same as the operating frequency of the video transmitting-receiving apparatus on the receiving side. When these operating frequencies are determined to be different from each other, the selector switch 100 is switched to a terminal connected to the IP conversion unit 101.

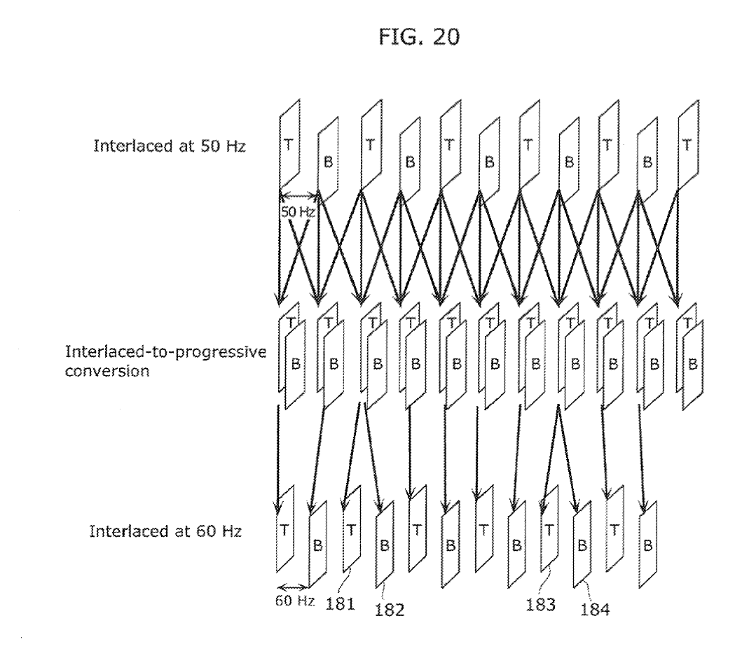

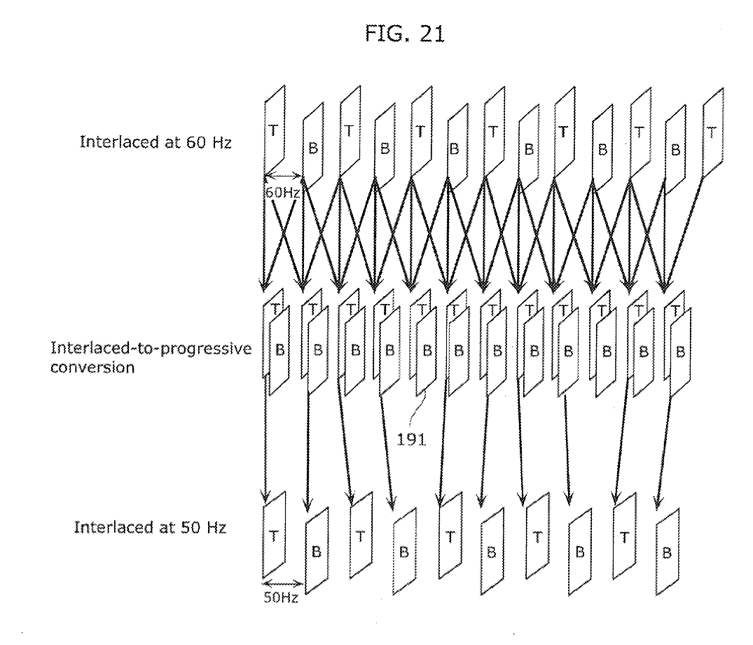

The IP conversion unit 101 converts the received interlaced video into progressive video. As is the case described using FIG. 20, the IP conversion unit 101 performs IP conversion to generate an image of one frame with reference to three fields including the preceding and succeeding fields.

The selector switch 102 is switched to a lower terminal bypassing the image reduction unit 103 when the 50 Hz-60 Hz arrangement unit 21 determines that the operating frequency of the video transmitting-receiving apparatus 5 is the same as the operating frequency of the video transmitting-receiving apparatus on the receiving side. When these operating frequencies are determined to be different from each other, the selector switch 102 is switched to a terminal connected to the image reduction unit 103. The selector switch 104 is switched to a lower terminal bypassing the frame reduction unit 105 in Embodiment 2. The frame reduction unit 105 is described in Embodiment 3 below.

As shown in FIG. 5, when the 50 Hz-60 Hz arrangement unit 21 determines that the operating frequency of the video transmitting-receiving apparatus 5 is different from the operating frequency of the video transmitting-receiving apparatus on the receiving side, the full HD interlaced video inputted to the input unit 20 is converted into full HD progressive video by IP conversion performed by the IP conversion unit 101 and then into HD progressive video having a resolution reduced by the image reduction unit 103. As can be seen from FIG. 6, in the input unit 20 in Embodiment 2, conversion of the operating frequency (i.e., between 50 Hz and 60 Hz) is not performed on the progressive video obtained by the IP conversion and the progressive video obtained by the resolution reduction. Thus, the selector switch 100, the IP conversion unit 101, the selector switch 102, the image reduction unit 103, the selector switch 104, and the frame reduction unit 105 operate at the same operating frequency.

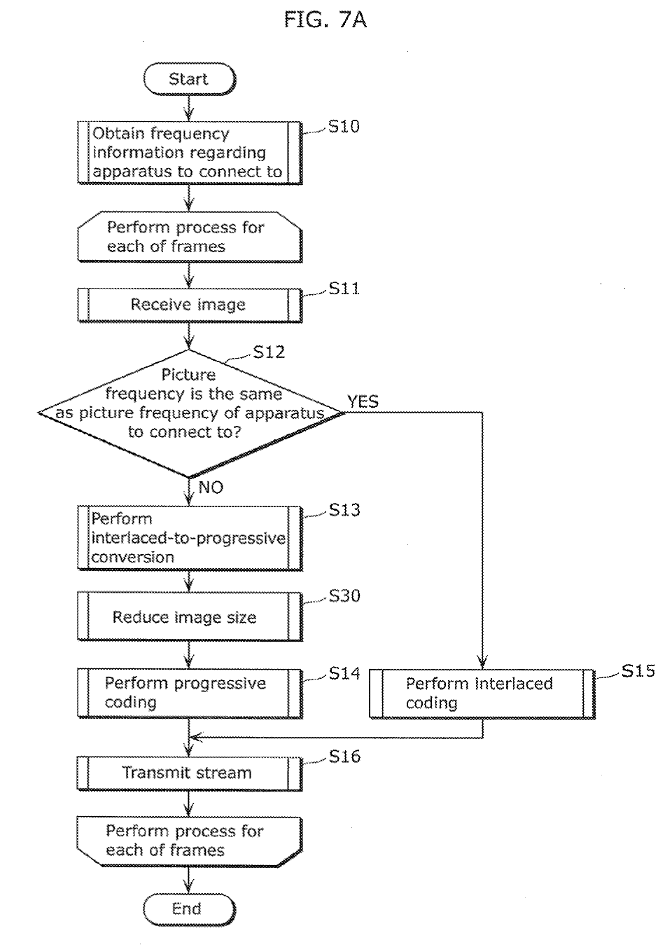

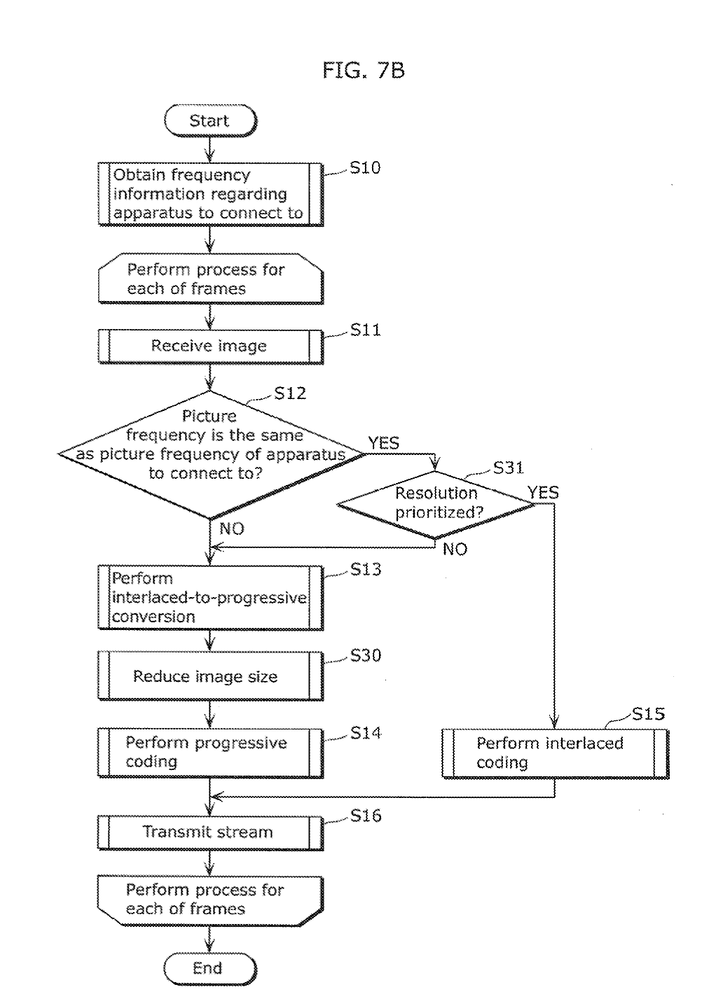

Each of FIG. 7A and FIG. 7B is a flowchart showing an operation for IP conversion including resolution reduction that is performed by the video transmitting-receiving apparatus in Embodiment 2. In the following, an explanation is given only about a difference between the operation including resolution reduction that is performed by the video transmitting-receiving apparatus shown in FIG. 7A in Embodiment 2 and the operation performed by the video transmitting-receiving apparatus shown in FIG. 2A in Embodiment 1.

When the 50 Hz-60 Hz arrangement unit 21 determines that the operating frequencies are different from each other (NO in S12), the selector switch 100 of the input unit 20 is switched to the corresponding terminal so that the IP conversion unit 101 performs IP conversion to convert the interlaced video into the progressive video (S13). Next, when the interlaced video is converted into the progressive video without changing the resolution, the number of pixels per second is doubled. Thus, the selector switch 102 is switched to the corresponding terminal so that the image reduction unit 103 converts the video into the progressive video having the reduced resolution (S30). Then, the coding unit 22 codes the progressive video (S14).

When the 50 Hz-60 Hz arrangement unit 21 determines that the operating frequencies are the same (YES in S12), the selector switch 100, the selector switch 102, and the selector switch 104 are switched to the respective corresponding terminals so that the IP conversion unit 101, the image reduction unit 103, and the frame reduction unit 105 that is described later are bypassed. Then, the coding unit 22 codes the interlaced video (S15).

Embodiment 2 has an advantage that stable communication can be achieved by reducing the resolution of the progressive video obtained by the IP conversion and thus preventing an increase in the bit rate of the coded stream. This advantage can be further applied to another example of Embodiment 2 as follows. Even when the operating frequency of the video transmitting-receiving apparatus 5 is the same as the operating frequency of the video transmitting-receiving on the receiving side, IP conversion and image size reduction may be performed in the case where the mode prioritizing the resolution is not set. FIG. 7B is a flowchart showing another example of the operation for IP conversion including resolution reduction that is performed by the video transmitting-receiving apparatus. Suppose that the 50 Hz-60 Hz arrangement unit 21 determines that the operating frequency of the video transmitting-receiving apparatus 5 is the same as the operating frequency of the video transmitting-receiving apparatus on the receiving side. As shown in FIG. 7B, even in this case, when the user does not prioritize the resolution (NO in S31), the received interlaced video may be converted into the progressive video (S13) and also the image size may be reduced so that HD progressive coding can be performed (S14).

By converting the interlaced video into the progressive video and reducing the resolution using the image reduction unit 103, the number of pixels per second is reduced and the bit rate of the coded stream is thus advantageously reduced as explained above based on the relationship between the video format and the number of pixels shown in FIG. 4.

It should be noted that, in Embodiment 2, the selector switch 104 bypasses the frame reduction unit 105. Therefore, the coding unit 22 codes all the frames (fields), which means that the number of frames is not reduced.

### Embodiment 3

In Embodiment 2 above, an increase in the bit rate after the IP conversion can be appropriately reduced by reducing the resolution of the frames obtained by the IP conversion.

In Embodiment 3, an increase in the bit rate of the coded stream is reduced by coding the reduced number of frames, instead of reducing the resolution of the progressive video.

As explained above based on the relationship between the video format and the number of pixels shown in FIG. 4, the number of pixels per second is almost doubled when the full HD interlaced video is converted into the full HD progressive video. When the number of frames per second of the full HD progressive video is reduced by half, the number of pixels per second becomes the same as the number of pixels per second of the full HD interlaced video.

On account of this, when the operating frequency 50 Hz or 60 Hz is different between the video transmitting-receiving apparatus on the transmitting side and the video transmitting-receiving apparatus on the receiving side, the conversion from the full HD interlaced video to the full HD [frames-reduced-by-half] progressive video allows a change in the bit rate of the coded stream caused due to the different operating frequency of video transmitting-receiving apparatus on the receiving side to be small. Thus, the communication load of the network is smoothed out and, as a result, stable communication can be achieved.

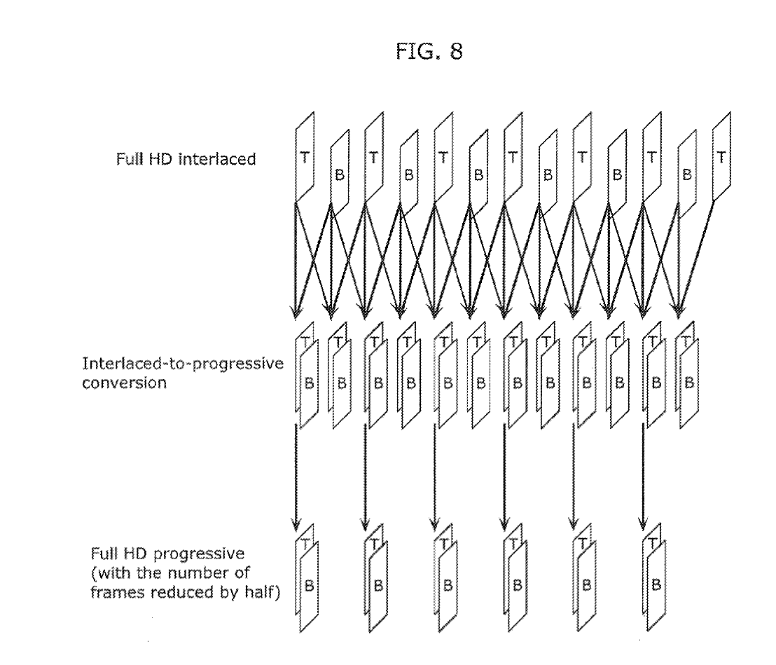

FIG. 8 is a diagram explaining the input unit 10 that performs frame reduction in Embodiment 3. The full HD interlaced video is converted into the full HD progressive video by IP conversion, and is next converted into the full HD [frames-reduced-by-half] progressive video where the number of frames is reduced by half.

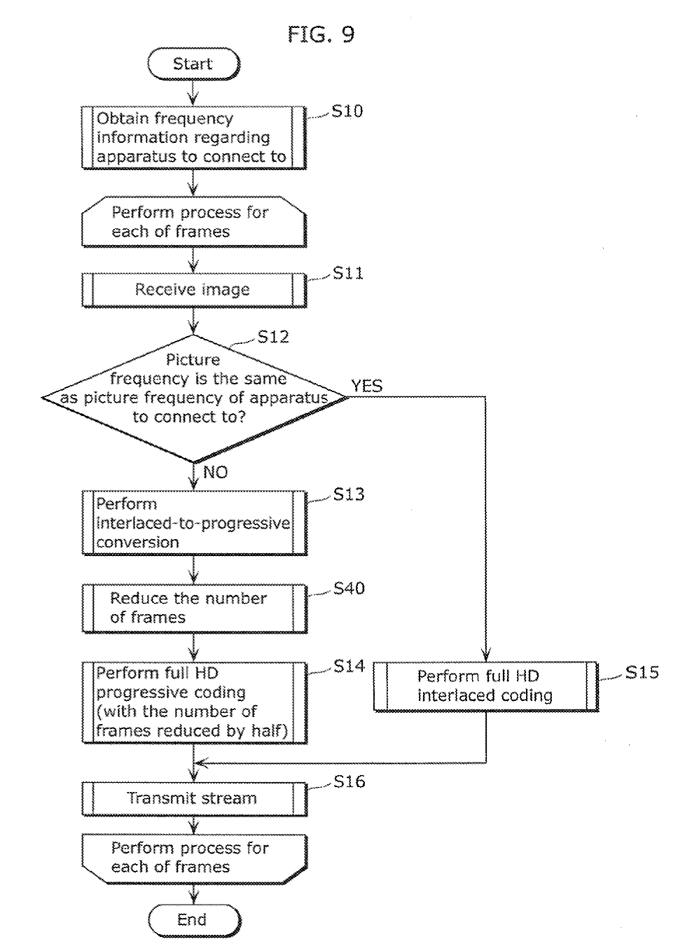

FIG. 5 is a block diagram showing a configuration of the input unit 20 in Embodiment 3. FIG. 9 is a flowchart showing a video transmitting method including frame reduction in Embodiment 3. In the following, an explanation is given only about a difference between: the flowchart of FIG. 9 showing an operation for IP conversion including frame reduction that is performed by the video transmitting-receiving apparatus in Embodiment 3; and the flowchart shown in FIG. 2A in Embodiment 1.

When the 50 Hz-60 Hz arrangement unit 21 determines that the operating frequencies are different from each other (NO in S12), the selector switch 100 of the input unit 20 is switched to the corresponding terminal so that the IP conversion unit 101 performs IP conversion to convert the full HD interlaced video into the full HD progressive video (S13). Next, since the resolution is not to be reduced, the selector switch 102 is set to bypass the image reduction unit 103. Here, when the received full HD interlaced video is converted into the full HD progressive video without changing the number of frames, the number of pixels per second is doubled. Thus, the selector switch 104 is switched to the corresponding terminal so that the frame reduction unit 105 converts the full HD progressive video into the full HD [frames-reduced-by-half] progressive video where the number of frames is reduced by half (S40). Then, the coding unit 22 codes the full HD [frames-reduced-by-half] progressive video (S14).

When the 50 Hz-60 Hz arrangement unit 21 determines that the operating frequencies are the same (YES in S12), the selector switch 100, the selector switch 102, and the selector switch 104 are switched to the respective corresponding terminals so that the IP conversion unit 101, the image reduction unit 103, and the frame reduction unit 105 are bypassed. Then, the coding unit 22 codes the full HD interlaced video (S15).

The frame reduction unit 105 reduces by half the number of frames per unit time of the full HD progressive video obtained by the IP conversion. Since the number of frames is reduced in this case, a problem is that motion smoothness is compromised. However, as explained above based on the relationship between the video format and the number of pixels shown in FIG. 4, the number of pixels per second can be reduced. Thus, this case has an advantage that the bit rate of the coded stream is low.

### Embodiment 4

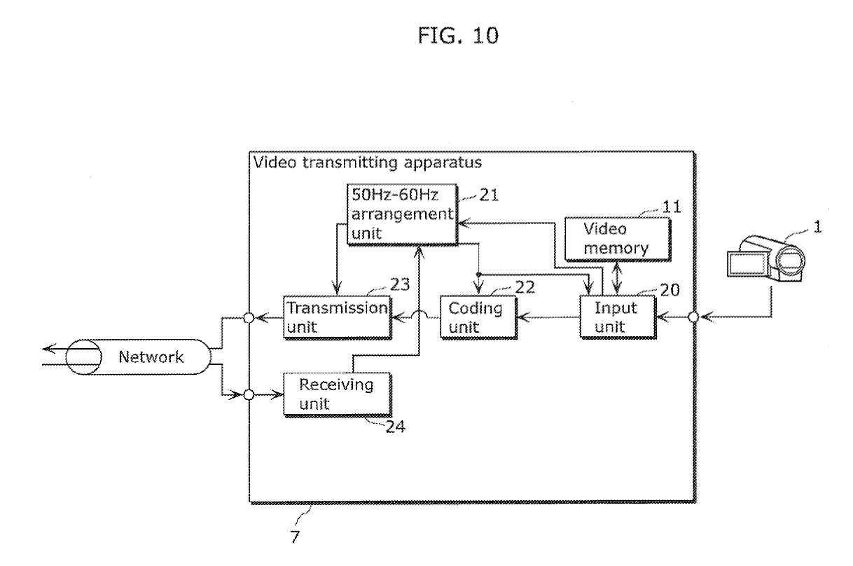

FIG. 10 is a block diagram showing a configuration of a video transmitting apparatus in Embodiment 4. In FIG. 10, units performing the same operations as the units included in the video transmitting-receiving apparatuses shown in FIG. 1 and FIG. 5 are assigned the same numbers as used in FIG. 1 and FIG. 5 and explanations about such units are omitted here.

A video transmitting apparatus 7 in Embodiment 4 is connected to a camera 1, and has only a function of transmitting a coded video stream to an apparatus on the receiving side. The video transmitting apparatus 7 includes a video memory 11, an input unit 20, a 50 Hz-60 Hz arrangement unit 21, a coding unit 22, a transmission unit 23, and a receiving unit 24.

As shown in this diagram, although not having a function of decoding the video, the video transmitting apparatus 7 includes the receiving unit 24 in order for the 50 Hz-60 Hz arrangement unit 21 to obtain, from a video receiving apparatus to connect to, frequency information indicating whether the operating frequency of the video receiving apparatus is 50 Hz or 60 Hz.

Moreover, the video transmitting apparatus 7 does not include a display unit. Therefore, when determining whether the operating frequency of the video transmitting apparatus 7 is the same as the operating frequency of the video receiving apparatus on the receiving side, the 50 Hz-60 Hz arrangement unit 21 makes an inquiry to the input unit 20 about whether the operating frequency of the video transmitting apparatus 7 is 50 Hz or 60 Hz.

When the 50 Hz-60 Hz arrangement unit 21 determines that the operating frequency of the video transmitting apparatus 7 is the same as the operating frequency of the video transmitting apparatus on the receiving side, the coding unit 22 codes the interlaced video outputted from the input unit 20 to generate an interlaced video stream.

When the 50 Hz-60 Hz arrangement unit 21 determines that the operating frequency of the video transmitting apparatus 7 is different from the operating frequency of the video receiving apparatus on the receiving side, the input unit 20 performs IP conversion on the interlaced video signal inputted to the input unit 20 to convert the interlaced video into progressive video. Then, the coding unit 22 codes the progressive video to generate a progressive video strew

### Embodiment 5

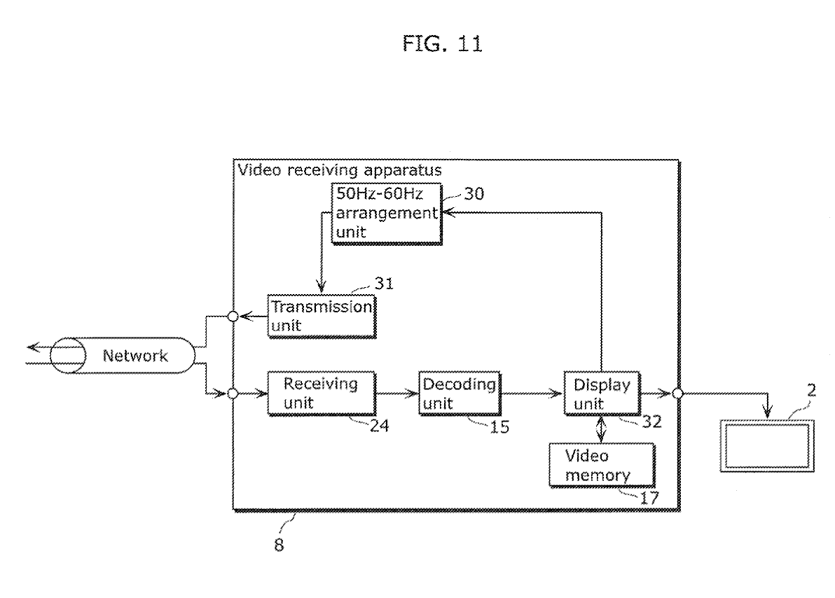

FIG. 11 is a block diagram showing a configuration of a video receiving apparatus in Embodiment 5. In FIG. 11, units performing the same operations as the units included in the video transmitting-receiving apparatuses shown in FIG. 1 and FIG. 5 are assigned the same numbers as used in FIG. 1 and FIG. 5 and explanations about such units are omitted here.

A video receiving apparatus 8 in Embodiment 5 is connected to a display 2, and has only a function of receiving and displaying a coded video stream. The video receiving apparatus 8 includes a decoding unit 15, a video memory 17, a receiving unit 24, a 50 Hz-60 Hz arrangement unit 30, a transmission unit 31, and a display unit 32.

As shown in this diagram, although not having a function of coding the video, the video receiving apparatus 8 includes the 50 Hz-60 Hz arrangement unit 30 that obtains the operating frequency of the video receiving apparatus 8 from the display unit 32 in order to inform the 50 Hz-60 Hz arrangement unit 21 of the video transmitting apparatus to connect to as to whether the operating frequency of the video receiving apparatus 8 is 50 Hz or 60 Hz. Then, the 50 Hz-60 Hz arrangement unit 30 generates frequency information indicating the obtained operating frequency and transmits, via the network, the frequency information from the transmission unit 31 to the video transmitting apparatus to connect to.

In this way, with the configuration of the video receiving apparatus 8 in Embodiment 5, the video transmitting apparatus to connect to can determine whether the operating frequency of this video transmitting apparatus is the same as the operating frequency of the video receiving apparatus 8 indicated by the frequency information informed via the network.

When the operating frequencies on the transmitting side and the receiving side are the same, the video transmitting apparatus can transmit the coded stream of the interlaced video to the video receiving apparatus 8. Then, the video receiving apparatus 8 can correctly decode and display the received coded stream of the interlaced video.

When the operating frequencies on the transmitting side and the receiving side are different from each other, the video transmitting apparatus can transmit the coded stream of the progressive video to the video receiving apparatus 8. Then, the video receiving apparatus 8 can correctly decode and display the received coded stream of the progressive video with only a slight loss in image quality.

### Embodiment 6

Embodiments 1 to 5 above each describe the case where the image quality and maximum resolution of the video transmitted by the video transmitting-receiving apparatus is not specified by a user setting. However, the present invention is not limited to these embodiments. Embodiment 6 describes the case where the image quality and maximum resolution of video transmitted by a video transmitting-receiving apparatus is specified by a user setting

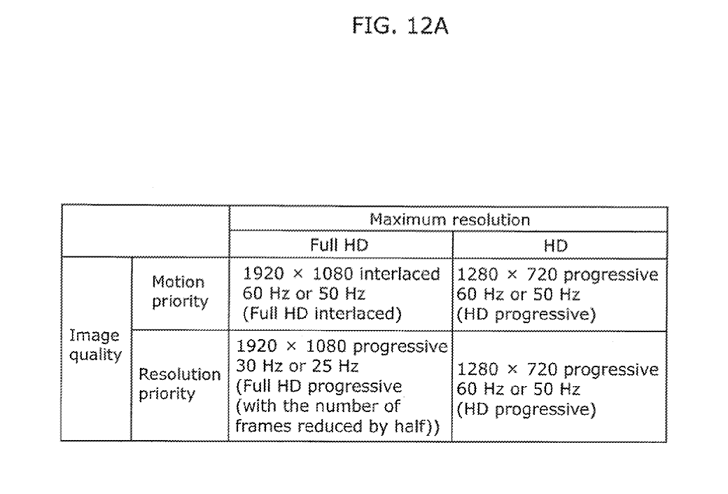

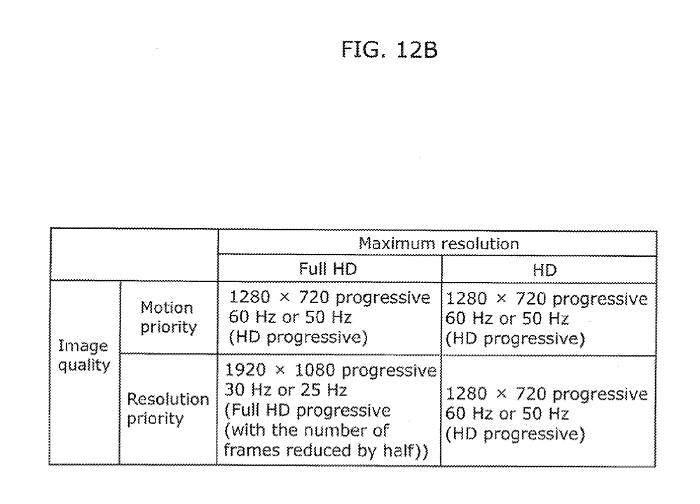

FIG. 12A is a diagram showing a relationship between a user setting of a coding mode and a corresponding coded image in the case where a video transmitting-receiving apparatus is not assumed to communicate with a video transmitting-receiving having a picture frequency different from a picture frequency of the aforementioned video transmitting-receiving apparatus, in Embodiment 6.

To be more specific, FIG. 12A assumes the case where the picture frequency of the video transmitting-receiving apparatus on the transmitting side is always the same as the picture frequency of the video transmitting-receiving apparatus on the receiving side. FIG. 12B is a diagram showing a relationship between a user setting of a coding mode and a corresponding coded image in the case where a video transmitting-receiving apparatus is assumed to communicate with a video transmitting-receiving apparatus having a picture frequency different from a picture frequency of the aforementioned video transmitting-receiving apparatus, in Embodiment 6.

To be more specific, FIG. 12B assumes the case where the picture frequency of the video transmitting-receiving apparatus on the transmitting side is different from the picture frequency of the video transmitting-receiving apparatus on the receiving side. For the case where the picture frequencies are different from each other, the video transmitting-receiving apparatus on the receiving side is set so as to convert the picture frequency to reproduce the video without causing a serious loss in image quality.

A configuration of a video transmitting apparatus or a video transmitting-receiving apparatus in Embodiment 6 is different from the video transmitting-receiving apparatus 5 shown in FIG. 1 or the video transmitting apparatus 7 shown in 10 in that, for example, an input unit 20 in Embodiment 6 further includes, in addition to the configuration shown in FIG. 1 or FIG. 10, an operation unit and a mode setting holding unit which are not illustrated.

The operation unit receives an input to the video transmitting-receiving apparatus 5 or the video transmitting 7 from a user operation.

On the basis of the input received by the operation unit, the mode setting holding unit holds a coding mode setting including an image quality setting specified by the user.

The video transmitting-receiving apparatus configured as described thus far in Embodiment 6 operates as follows. More specifically, suppose that the video transmitting-receiving apparatus is not assumed to communicate with a video transmitting-receiving apparatus having a different picture frequency. In this case, as shown in FIG. 12A, when “Full HD” is set as the maximum resolution and “Motion priority” is set as the image quality, the input unit 20 does not perform IP conversion and the full HD interlaced video captured by a camera 1 is coded as it is and then transmitted.

When “Full HD” is set as the maximum resolution and “Resolution priority” is set as the image quality, the input unit 20 performs IP conversion on the full HD interlaced video captured by the camera 1 and reduces the number of frames. Then, the full HD [frames-reduced-by-half] progressive video is coded and transmitted.

Regardless of whether “Motion priority” or “Resolution priority” is set as the image quality, when “HD” is set as the maximum resolution, the input unit 20 performs IP conversion and reduces the resolution. Then, the HD progressive video is coded and transmitted.

Suppose that the video transmitting-receiving apparatus is not assumed to communicate with the video transmitting-receiving apparatus having the different picture frequency, and that “Full HD” and “Motion priority” are set as the maximum resolution and the image quality, respectively. In this case, by controlling the operation performed by the video transmitting-receiving apparatus as described, the full HD interlaced video is coded and transmitted. Thus, although the resolution is lower as compared to the progressive video, the interlaced video showing more smooth motion can be transmitted with the maximum resolution maintained at full HD.

Moreover, when “Full HD” is set as the maximum resolution and “Resolution priority” is set as the image quality, the full HD [frames-reduced-by-half] progressive video is coded and transmitted. Thus, although the motion smoothness is reduced as compared to the interlaced video, the higher-resolution progressive video having high error tolerance can be transmitted with the maximum resolution and the bit rate maintained.

When “HD” is set as the maximum resolution, the HD progressive video is coded and transmitted. Here, the maximum resolution is lower as compared to the full HD progressive video. However, progressive video is higher in resolution and error tolerance than interlaced video. Moreover, in this case, the picture frequency is higher as compared to the full HD [frames-reduced-by-half] progressive video. Hence, the progressive video showing more smooth motion can be transmitted

Suppose that the video transmitting-receiving apparatus is assumed to communicate with the video transmitting-receiving apparatus having the different picture frequency, and that “Full HD” and “Motion priority” are set by the user as the maximum resolution and the image quality, respectively, as shown in FIG. 12B. In this case, the input unit 20 performs IP conversion and reduces the resolution. Then, the HD progressive video is coded and transmitted.

Moreover, when “Full HD” is set as the maximum resolution and “Resolution priority” is set as the image quality, the input unit 20 performs IP conversion on the full HD interlaced video captured by the camera 1 and reduces the number of frames. Then, the full HD [frames-reduced-by-half] progressive video is coded and transmitted.

Regardless of whether “Motion priority” or “Resolution priority” is set as the image quality, when “HD” is set as the maximum resolution, the input unit 20 performs IP conversion and reduces the resolution. Then, the HD progressive video is transmitted.

As described, the difference between FIG. 12A and FIG. 12B is caused when “Full HD” is set as the maximum resolution and “Motion priority” is set as the image quality. When the video transmitting-receiving apparatus is assumed to communicate with the video transmitting-receiving apparatus having the different picture frequency, the video transmitting-receiving apparatus transmits the HD progressive video with the reduced resolution instead of transmitting the full HD interlaced video.

Here, the reasons why the video transmitting-receiving apparatus transmits the HD progressive video instead of transmitting the full HD interlaced video are as follows. Interlaced video is lower in error tolerance than progressive video. Moreover, when the video transmitting-receiving apparatus on the receiving side converts the picture frequency of the received interlaced video, an extremely serious loss in image quality is caused as described above with reference to FIG. 18A and FIG. 18B.

Suppose that the video transmitting-receiving apparatus is assumed to communicate with the video transmitting-receiving apparatus having the different picture frequency, and that “Full HD” and “Motion priority” are set by the user as the maximum resolution and the image quality, respectively. In this case, the video transmitting-receiving apparatus is controlled so that the HD progressive video is coded and transmitted. With this, an increase in the bit rate is prevented, and the video transmitting-receiving apparatus having the different picture frequency can reproduce the video with only a slight loss in image quality.

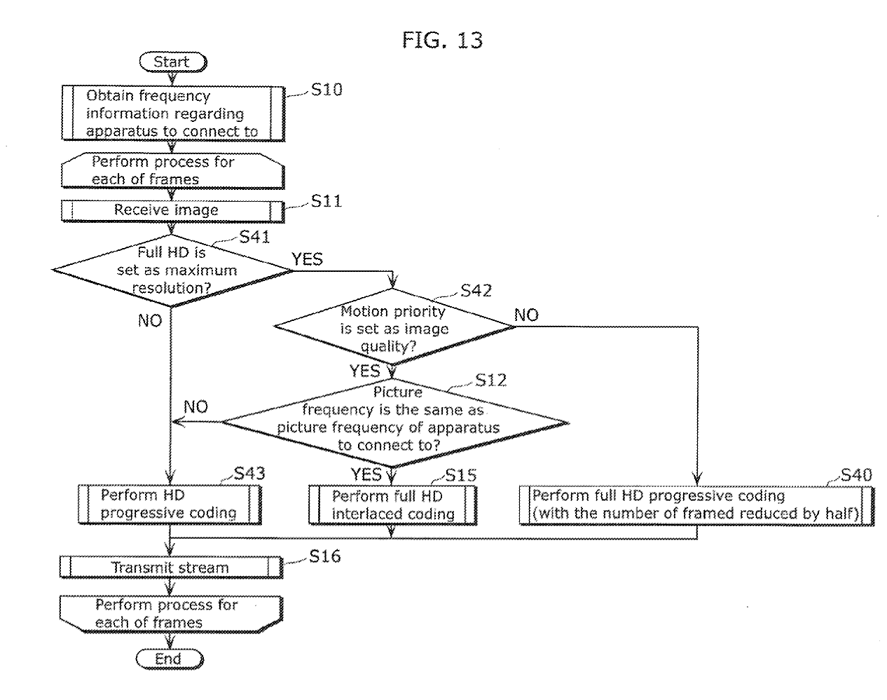

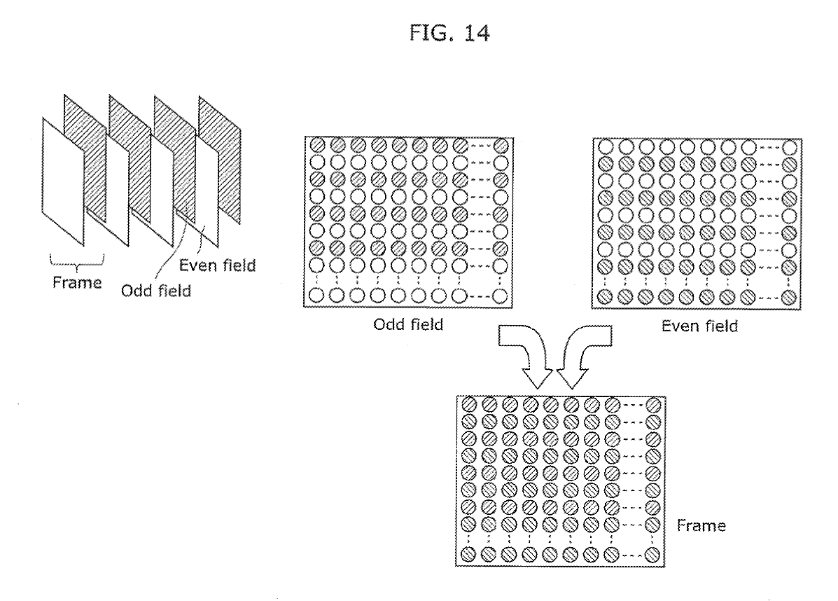

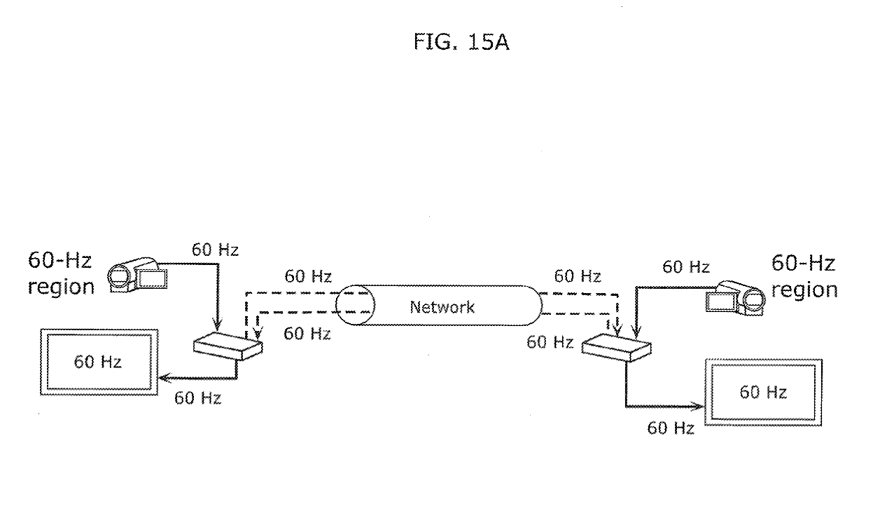

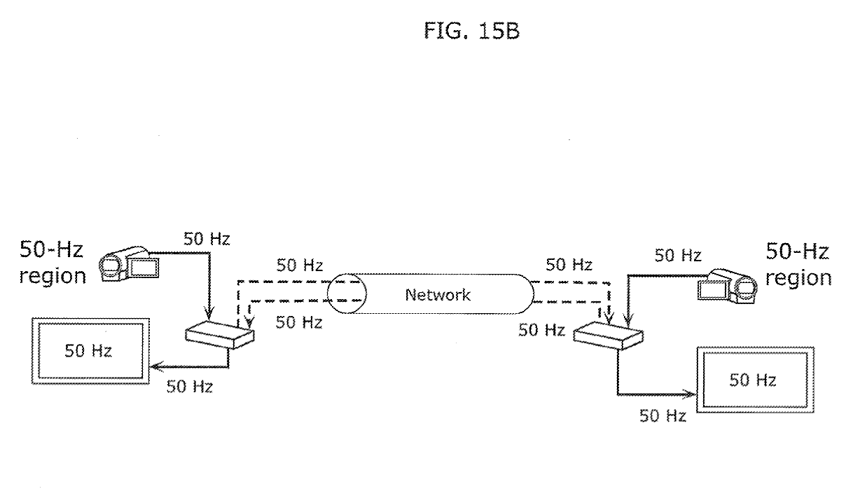

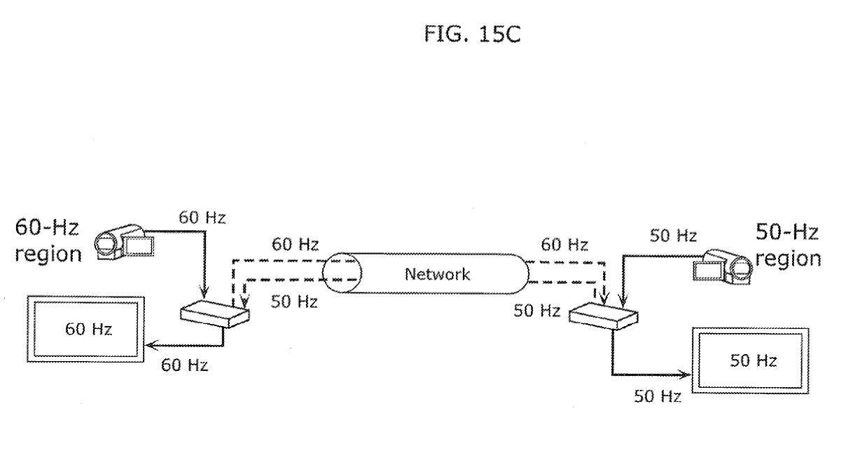

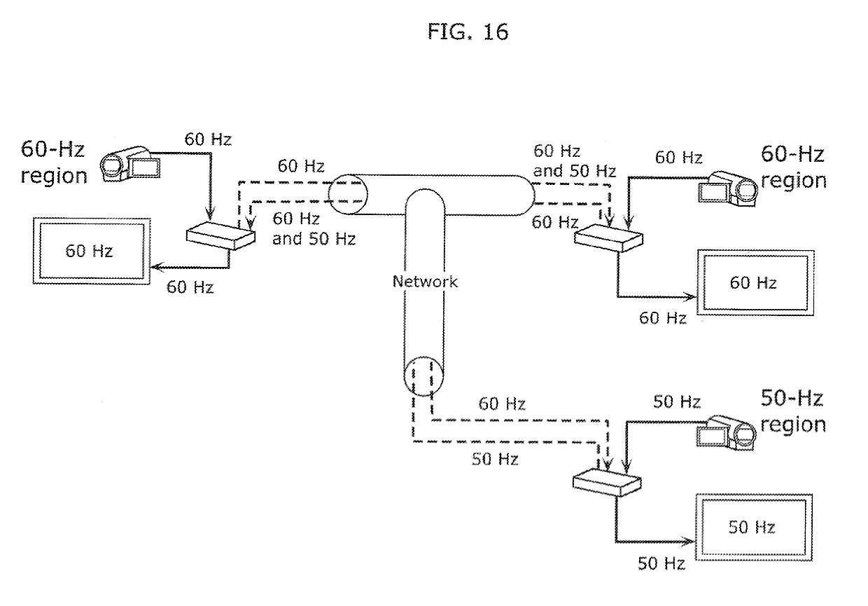

Suppose that the user setting is provided as shown in FIG. 12A and FIG. 12B. The following describes an operation performed when the video transmitting-receiving apparatus on the transmitting side determines whether or not the video transmitting-receiving apparatus on the receiving side has the same picture frequency as the video transmitting-receiving apparatus on the transmitting side and switches the process between FIG. 12A and FIG. 12B according to the result of the determination. FIG. 13 is a flowchart showing an example of the operation performed by the video transmitting-receiving apparatus to switch the coding mode according to the picture frequency of the video transmitting-receiving apparatus to connect to when the user setting of the coding mode is provided.

Firstly, the 50 Hz-60 Hz arrangement unit 21 of the video transmitting-receiving apparatus 5 obtains the frequency information received by the receiving unit 24 and indicating whether the operating frequency of the television system used by the video transmitting-receiving apparatus to connect to is 50 Hz or 60 Hz (S10). The input unit 20 temporarily stores a video signal received from the camera 1 into the video memory 11 (S11).

The 50 Hz-60 Hz arrangement unit 21 determines whether or not “Full HD” is set as the maximum resolution in the stored user mode setting (S41). When it is determined that “Full HD” is not set as the maximum resolution (NO in S41), the IP conversion unit 101 performs IP conversion to convert the full HD interlaced video into the full HD progressive video. After this, the image reduction unit 103 reduces the resolution and the coding unit 22 codes the HD progressive video (S43).

When determining that “Full HD” is set as the maximum resolution in the stored user mode setting (YES in S41), the 50 Hz-60 Hz arrangement unit 21 further determines whether or not “Motion priority” is set as the image quality in the stored mode setting (S42). When it is determined that “Motion priority” is not set as the image quality (NO in S42), the IP conversion unit 101 of the input unit 20 performs IP conversion to convert the full HD interlaced video into the full HD progressive video with the number of frames maintained. With this, the number of pixels per second is doubled. Thus, the frame reduction unit 105 converts the full HD progressive video into the full HD [frames-reduced-by-half] progressive video where the number of frames is reduced by half, and the coding unit 22 codes this video (S40).

When determining that “Motion priority” is set as the image quality in the stored user mode setting (YES in S42), the 50 Hz-60 Hz arrangement unit 21 further obtains the frequency information received by the receiving unit 24 and indicating whether the operating frequency of the television system used by the video transmitting-receiving apparatus to connect to is 50 Hz or 60 Hz. Then, the 50 Hz-60 Hz arrangement unit 21 determines, by comparison, whether the operating frequency is the same as the operating frequency of the video transmitting-receiving apparatus on the receiving side that is received by the receiving unit 24 (S12).

In S12, when the 50 Hz-60 Hz arrangement unit 21 determines that the operating frequencies on the transmitting side and the receiving side are the same (YES in S12), the coding unit 22 codes the full HD interlaced video outputted from the input unit 20 into a full HD interlaced video stream (S15).

When the 50 Hz-60 Hz arrangement unit 21 determines that the operating frequencies are different from each other (NO in S12), the process proceeds to S43 where the HO progressive video is coded.

The transmission unit 23 transmits the stream coded by the coding unit 22 to the video transmitting-receiving apparatus on the receiving side via the network (S16).

The operation from S11 to S16 described thus far s performed for each of frames included in the video.

By controlling the operation performed by the video transmitting-receiving apparatus on the transmitting side, the following can be achieved.

[1] Suppose that the picture frequency of the video transmitting-receiving apparatus to connect to is the same as the picture frequency of the video transmitting-receiving apparatus on the transmitting side, and that “Full HD” and “Motion priority” are set as the maximum resolution and the image quality, respectively. In this case, the full HD interlaced video is transmitted. Thus, although the resolution is lower as compared to the progressive video, the interlaced video showing more smooth motion can be transmitted with the maximum resolution maintained at full HD.

[2] When “Full HD” is set as the maximum resolution and “Resolution priority” is set as the image quality, the full HD [frames-reduced-by-half] progressive video is transmitted. Thus, although the motion smoothness is reduced as compared to the interlaced video, the higher-resolution progressive video having high error tolerance can be transmitted with the maximum resolution maintained at full HD.

[3] When “HD” is set as the maximum resolution, the HD progressive video is transmitted regardless of the image quality setting. Here, the maximum resolution is lower as compared to the full HD progressive video. However, progressive video is higher in resolution and error tolerance than interlaced video. Moreover, in this case, the picture frequency is higher as compared to the full HD [frames-reduced-by-half] progressive video. Hence, the progressive video showing more smooth motion can be transmitted

Although the video transmitting apparatus 7, the video receiving apparatus 8, and the video transmitting-receiving apparatus 5 according to the present invention have been described by way of the embodiments, it is to be noted that the present invention is not limited to these embodiments. Various changes and modifications will be apparent to those skilled in the art, and the features of the embodiments may be combined so long as they are not mutually contradictory. Therefore, unless such changes, modifications, and combinations depart from the scope of the present invention, they should be construed as being included therein.

### INDUSTRIAL APPLICABILITY

The present invention can be used in transmitting and receiving high-quality images between the regions using the 50 Hz and 60 Hz television systems. In particular, the present invention can be used in a video conference, a video phone, video distribution, and a monitoring system that uses video.

### REFERENCE SIGNS LIST

1 Camera

2 Display

3 Video transmitting-receiving apparatus

5 Video transmitting-receiving apparatus

7 Video transmitting apparatus

8 Video receiving apparatus

10 Input unit

11 Video memory

12 Coding unit

13 Transmission unit

14 Receiving unit

15 Decoding unit

16 Display unit

17 Video memory

20 Input unit

21 50 Hz-60 Hz arrangement unit

22 Coding unit

23 Transmission unit

24 Receiving unit

30 Arrangement unit

31 Transmission unit

32 Display unit

100 Selector switch

101 IP conversion unit

102 Selector switch

103 Image reduction unit

104 Selector switch

105 Frame reduction unit

1-12. (canceled)

13. A video transmitting apparatus comprising:
an input unit configured to receive interlaced video captured by a predetermined image pickup device and output video in a predetermined image format;
a receiving unit configured to receive, from a video receiving apparatus to which the received interlaced video is to be transmitted, frequency information indicating a picture frequency representing the number of pictures displayed per unit time by the video receiving apparatus, each of the pictures being (i) a top field or a bottom field that is included in interlaced video or (ii) a frame included in progressive video;
an arrangement unit configured to determine whether the picture frequency of the received interlaced video is a same as the picture frequency indicated by the frequency information received from the video receiving apparatus;
a coding unit configured to code the video outputted from the input unit to generate a stream; and
a transmission unit configured to transmit the generated stream to the video receiving apparatus,
wherein the picture frequency indicates whether the video receiving apparatus is for a 50 Hz television system or a 60 Hz television system, and
the input unit is configured to (i) convert the received interlaced video into progressive video and output the progressive video when the arrangement unit determines that the picture frequency of the received interlaced video is different from the picture frequency indicated by the frequency information received from the video receiving apparatus, and (ii) output the received interlaced video with no change when the arrangement unit determines that the picture frequency of the received interlaced video is the same as the picture frequency indicated by the frequency information received from the video receiving apparatus.

14. The video transmitting apparatus according to claim 13,
wherein, when converting the interlaced video into the progressive video, the input unit is configured to convert the interlaced video into the progressive video while maintaining the picture frequency of the interlaced video.

15. The video transmitting apparatus according to claim 13,
wherein the arrangement unit is further configured to determine whether one of a user input and a state of a communication channel satisfies a predetermined condition, when determining that the picture frequency of the video received by the video transmitting apparatus is the same as the picture frequency indicated by the frequency information received from the video receiving apparatus, and
the input unit is configured to convert the interlaced video into the progressive video when the arrangement unit determines that the predetermined condition is satisfied.

16. The video transmitting apparatus according to claim 13,
wherein the receiving unit is configured to receive pieces of frequency information each of which is from a different one of a plurality of video receiving apparatuses, and
the input unit is configured to convert the interlaced video into the progressive video when the arrangement unit determines that at least one of the picture frequencies indicated by the pieces of frequency information received from the video receiving apparatuses is different from the picture frequency of the video received by the video transmitting apparatus.

17. The video transmitting apparatus according to claim 13,
wherein, when converting the interlaced video into the progressive video, the input unit is further configured to reduce the number of pixels included in each of frames of the progressive video in order for the number of pixels per second of the progressive video obtained by the conversion to be smaller than or equal to the number of pixels per second of the interlaced video before the conversion.

18. The video transmitting apparatus according to claim 13,
wherein, when converting the interlaced video into the progressive video, the input unit is further configured to reduce the number of frames of the progressive video in order for the number of pixels per second of the progressive video obtained by the conversion to be smaller than or equal to the number of pixels per second of the interlaced video before the conversion.

19. The video transmitting apparatus according to claim 13, further comprising
a mode setting holding unit configured to hold a mode setting of a coding mode, the mode setting being set by a user and including image quality specification,
wherein the input unit is configured to:
(i) convert the interlaced video into the progressive video and reduce the number of frames of the progressive video in order for the number of pixels per second of the progressive video obtained by the conversion to be smaller than or equal to the number of pixels per second of the interlaced video before the conversion, when the image quality specification included in the held mode setting does not indicate motion priority;
(ii) output the interlaced video with no change, when the image quality specification included in the held mode setting indicates motion priority and the arrangement unit determines the picture frequencies are the same; and
(iii) convert the interlaced video into the progressive video, reduce the number of pixels included in each of frames of the progressive video in order for the number of pixels per second of the progressive video obtained by the conversion to be smaller than or equal to the number of pixels per second of the interlaced video before the conversion, and output the resulting progressive video, when the image quality specification included in the held mode setting indicates motion priority and the arrangement unit determines the picture frequencies are different from each other.

20. A video receiving apparatus which receives a video stream from a video transmitting apparatus and outputs video obtained by decoding the received video stream, the video receiving apparatus comprising:
a display unit configured to display the video obtained by the decoding;
a frequency obtainment unit configured to obtain whether a picture frequency representing the number of pictures displayed per unit time by the display unit corresponds to a 50 Hz television system or a 60 Hz television system, and to generate frequency information indicating the obtained picture frequency, each of the pictures being (i) a top field or a bottom field that is included in interlaced video or (ii) a frame included in progressive video;
a transmission unit configured to transmit the generated frequency information to the video transmitting apparatus; and
a decoding unit configured to receive, from the video transmitting apparatus, a video stream coded by the video transmitting apparatus based on the transmitted frequency information, and to decode the received video stream,
wherein the display unit is configured to output the video obtained by the decoding performed by the decoding unit.

21. A video transmitting-receiving apparatus serving as both: a second video transmitting apparatus that codes interlaced video and transmits the coded interlaced video to a first video receiving apparatus; and a second video receiving apparatus that receives a video stream from a first video transmitting apparatus, decodes the received video stream, and outputs the decoded video stream, the video transmitting-receiving apparatus comprising:
an input unit configured to receive interlaced video captured by a predetermined image pickup device and output video in a predetermined image format;
a receiving unit configured to receive, from the first video receiving apparatus, frequency information indicating a picture frequency representing the number of pictures displayed per unit time by the first video receiving apparatus, each of the pictures being (i) a top field or a bottom field that is included in interlaced video or (ii) a frame included in progressive video;
an arrangement unit configured to determine whether a picture frequency of the interlaced video received by the video transmitting-receiving apparatus is a same as the picture frequency indicated by the frequency information received from the first video receiving apparatus;
a coding unit configured to code the video outputted from the input unit to generate a stream;
a transmission unit configured to transmit the generated stream to the first video receiving apparatus;
a display unit configured to display the video obtained by the decoding;
a frequency obtainment unit configured to obtain whether a picture frequency representing the number of pictures displayed per unit time by the display unit corresponds to a 50 Hz television system or a 60 Hz television system, and to generate frequency information indicating the obtained picture frequency;
a transmission unit configured to transmit the generated frequency information to the first video transmitting apparatus; and
a decoding unit configured to receive, from the first video transmitting apparatus, a video stream coded by the first video transmitting apparatus based on the picture frequency indicated by the transmitted frequency information, and to decode the received video stream,
wherein the input unit is configured to (i) convert the interlaced video into progressive video and output the progressive video when the arrangement unit determines that the picture frequency of the video received by the video transmitting-receiving apparatus is different from the picture frequency indicated by the frequency information received from the first video receiving apparatus, and (ii) output the interlaced video with no change when the arrangement unit determines that the picture frequency of the video received by the video transmitting-receiving apparatus is the same as the picture frequency indicated by the frequency information received from the first video receiving apparatus, and
the display unit is configured to output the video obtained by the decoding performed by the decoding unit.

22. A video transmitting method comprising:
receiving interlaced video captured by a predetermined image pickup device and outputting video in a predetermined image format;
receiving, from a video receiving apparatus to which the received interlaced video is to be transmitted, frequency information indicating a picture frequency representing the number of pictures displayed per unit time by the video receiving apparatus, each of the pictures being (i) a top field or a bottom field that is included in interlaced video or (ii) a frame included in progressive video;
determining whether the picture frequency of the video received by the video transmitting apparatus is a same as the picture frequency indicated by the frequency information received from the video receiving apparatus;
(i) converting the received interlaced video into progressive video and outputting the progressive video when it is determined that the picture frequency of the interlaced video received by the video transmitting apparatus is different from the picture frequency indicated by the frequency information received from the video receiving apparatus, and (ii) outputting the received interlaced video with no change when it is determined that the picture frequency of the interlaced video is the same as the picture frequency indicated by the frequency information received from the video receiving apparatus;
coding one of the progressive video and the interlaced video that is outputted from the input unit to generate a stream; and
transmitting the generated stream to the video receiving apparatus.

23. A video receiving method of receiving a video stream from a video transmitting apparatus and outputting video obtained by decoding the received video stream, the video receiving method comprising:
obtaining whether a picture frequency representing the number of pictures displayed per unit time by a display unit corresponds to a 50 Hz television system or a 60 Hz television system, generating frequency information indicating the obtained picture frequency, and transmitting the generated frequency information to the video transmitting apparatus, each of the pictures being (i) a top field or a bottom field that is included in interlaced video or (ii) a frame included in progressive video;
receiving, from the video transmitting apparatus, a video stream coded by the video transmitting apparatus based on the picture frequency indicated by the transmitted frequency information;
decoding the received stream; and
displaying the video obtained by the decoding.

24. A non-transitory computer-readable recording medium for use in a computer, the recording medium having a computer program recorded thereon for causing the computer to function as the units of the video transmitting apparatus according to claim 13.
